(19) United States
(12) Patent Application Publication
(10) Pub. No.: US 2023/0332316 A1
(43) Pub. Date: Oct. 19, 2023

(54) POWER DISTRIBUTION FOR A HYDROGEN GENERATION SYSTEM

(71) Applicant: Ohmium International, Inc., Incline Village, NV (US)

(72) Inventors: Chockkalingam Karuppaiah, Fremont, CA (US); Rasool Aghatehrani, Redwood City, CA (US); Anil Kumar Adapa, Tadepalligudem (IN)

(21) Appl. No.: 18/135,571

(22) Filed: Apr. 17, 2023

Related U.S. Application Data
(60) Provisional application No. 63/332,176, filed on Apr. 18, 2022.

(51) Int. Cl. C25B 15/023; C25B 1/04; C25B 9/70; C25B 9/65

(52) U.S. Cl. CPC C25B 15/023; C25B 1/04; C25B 9/70; C25B 9/65

(57) ABSTRACT

A method and system for distributing power to a hydrogen generation system including a plurality of electrochemical stacks is disclosed. The method includes receiving a hydrogen generation request including an amount of hydrogen to produce during a particular time interval; receiving status data regarding the plurality of electrochemical stacks; selecting a set of electrochemical stacks of the plurality of electrochemical stacks that can fulfil the hydrogen generation request based, at least in part, on the status data; selecting a power distribution for the set of electrochemical stacks; and coupling the set of electrochemical stacks to the selected power distribution.

### CROSS-REFERENCE TO RELATED APPLICATIONS

This application claims the benefit of U.S. Provisional Application No. 63/332,176, filed Apr. 18, 2022, for “POWER DISTRIBUTION FOR A HYDROGEN GENERATION SYSTEM,” which is incorporated herein by reference in its entirety.

### FIELD OF THE DISCLOSURE

The present disclosure is generally related to hydrogen generation and, more specifically, to power distribution for hydrogen generation.

### BACKGROUND

Currently, hydrogen generation systems do not selectively control the power from the grid to individual electrochemical stacks. In addition, hydrogen generation systems do not determine which electrochemical stacks to use based on customer hydrogen demands. Moreover, hydrogen generation systems do not utilize the control of transformers and power converters to selectively provide power to specific electrochemical stacks. Therefore, a need exists for a power distribution system for a hydrogen generation system that addresses one or more of the foregoing issues.

### SUMMARY

According to one aspect, a method is provided for distributing power to a hydrogen generation system having a plurality of electrochemical stacks. The method includes receiving a hydrogen generation request including an amount of hydrogen to produce during a particular time interval. The method also includes receiving status data regarding the plurality of electrochemical stacks. In addition, the method includes selecting a set of electrochemical stacks of the plurality of electrochemical stacks that can fulfil the hydrogen generation request based, at least in part, on the status data. The method further includes selecting a power distribution for the set of electrochemical stacks and coupling the set of electrochemical stacks to the selected power distribution.

In some examples, the status data includes an indication of which electrochemical stacks of the plurality of electrochemical stacks are active and a rate of hydrogen production for each active electrochemical stack of the plurality of electrochemical stacks, and selecting the set of electrochemical stacks includes selecting the set of electrochemical stacks based which electrochemical stacks of the plurality of electrochemical stacks are active and the rate of hydrogen production for each active electrochemical stack of the plurality of electrochemical stacks.

In other examples, the status data includes the power distribution for one or more of the plurality of electrochemical stacks, and selecting the set of electrochemical stacks includes selecting an electrochemical stack that has a same power distribution as another selected electrochemical stack. Alternatively or in addition, selecting the set of electrochemical stacks includes selecting an electrochemical stack that has a different power distribution as another selected electrochemical stack.

In still other examples, the power distribution for the set of electrochemical stacks includes one or more of a power converter, a transformer, and a substation, and selecting the power distribution for the set of electrochemical stacks includes selecting the power distribution for one selected electrochemical stack that is the same as the power distribution of another selected electrochemical stack. Alternatively or in addition, selecting the power distribution for the set of electrochemical stacks includes selecting the power distribution for one selected electrochemical stack that is different from the power distribution of another selected electrochemical stack. In an example, selecting the power distribution for the set of electrochemical stacks includes balancing a power distribution load among a plurality of power distributions.

In some examples, the method further includes receiving power distribution data including an indication of any power distributions that will be out of service during the particular time interval, and selecting the power distribution for the set of electrochemical stacks includes excluding power distributions for selection that will be out of service during the particular time interval.

According to another aspect, a system is provided for distributing power to a hydrogen generation system having a plurality of electrochemical stacks. The system includes a communication interface to receive a hydrogen generation request including an amount of hydrogen to produce during a particular time interval. The system also includes a memory to store status data regarding the plurality of electrochemical stacks. In addition, the system includes one or more processors to select a set of electrochemical stacks of the plurality of electrochemical stacks that can fulfil the hydrogen generation request based, at least in part, on the status data. The one or more processors are also to select a power distribution for the set of electrochemical stacks. In addition, the one or more processors are to initiate coupling of the set of electrochemical stacks to the selected power distribution.

In some examples, the status data includes an indication of which electrochemical stacks of the plurality of electrochemical stacks are active and a rate of hydrogen production for at least one active electrochemical stack of the plurality of electrochemical stacks, and the one or more processors are to select the set of electrochemical stacks based which electrochemical stacks of the plurality of electrochemical stacks are active and the rate of hydrogen production for the at least one active electrochemical stack of the plurality of electrochemical stacks.

In other examples, the status data includes the power distribution for one or more of the plurality of electrochemical stacks, and the one or more processors are to select an electrochemical stack that has a same power distribution as another selected electrochemical stack. Alternatively, or in addition, the one or more processors are to select an electrochemical stack that has a different power distribution as another selected electrochemical stack. The power distribution includes one or more of a power converter, a transformer, and a substation. In some examples, the one or more processors are to select the power distribution for one selected electrochemical stack that is the same as the power distribution of another selected electrochemical stack. In other examples, the one or more processors are to select the power distribution for one selected electrochemical stack that is different from the power distribution of another selected electrochemical stack. In still other examples, the one or more processors are to balance a power distribution load among a plurality of power distributions.

In a further example, the memory stores power distribution data including an indication of any power distributions that will be out of service during the particular time interval, and the one or more processors to select the power distribution for the set of electrochemical stacks by excluding power distributions for selection that will be out of service during the particular time interval.

According to yet another aspect, a non-transitory computer-readable medium includes program code that, when executed by one or more processors, cause the one or more processors to perform the above-described method for distributing power to a hydrogen generation system having a plurality of electrochemical stacks.

### BRIEF DESCRIPTION OF THE DRAWINGS

The accompanying drawings illustrate embodiments and/or aspects of the disclosure and, together with the written description, serve to explain the principles of the disclosure. Wherever possible, the same reference numbers are used throughout the drawings to refer to the same or like elements of an embodiment. Non-limiting and non-exhaustive descriptions are described with reference to the following drawings. The components in the figures are not necessarily to scale, emphasis instead being placed upon illustrating principles of the disclosed embodiments.

FIG. 1 is a block diagram of a system for power distribution for a hydrogen generation, according to an embodiment.

FIG. 2 is a flowchart of a process performed by a power distribution module, according to an embodiment.

FIG. 3 is a flowchart of a process performed by a base module, according to an embodiment.

FIG. 4 is a flowchart of a process performed by a system module, according to an embodiment.

FIG. 5 is a flowchart of a process performed by a controller module, according to an embodiment.

FIG. 6 illustrates a system database, according to an embodiment.

FIG. 7 is a flowchart of a process performed by a E.N. base module, according to an embodiment.

FIG. 8 is a flowchart of a process performed by a data collection module, according to an embodiment.

FIG. 9 is a flowchart of a process performed by a power module, according to an embodiment.

FIG. 10 illustrates a stack database, according to an embodiment.

FIG. 11 illustrates a customer database, according to an embodiment.

FIG. 12 is a flowchart of a process performed by a C.N. base module, according to an embodiment.

FIG. 13 is a flowchart of a process performed by a customer module, according to an embodiment.

FIG. 14 illustrates a hydrogen database, according to an embodiment.

FIG. 15 is a flowchart of a method for distributing power to a hydrogen generation system, according to an embodiment.

### DETAILED DESCRIPTION

Some embodiments of this disclosure will now be discussed in detail. It can be understood that the embodiments are intended to be open-ended in that an item or items used in the embodiments is not meant to be an exhaustive listing of such items or items or meant to be limited to only the listed item or items.

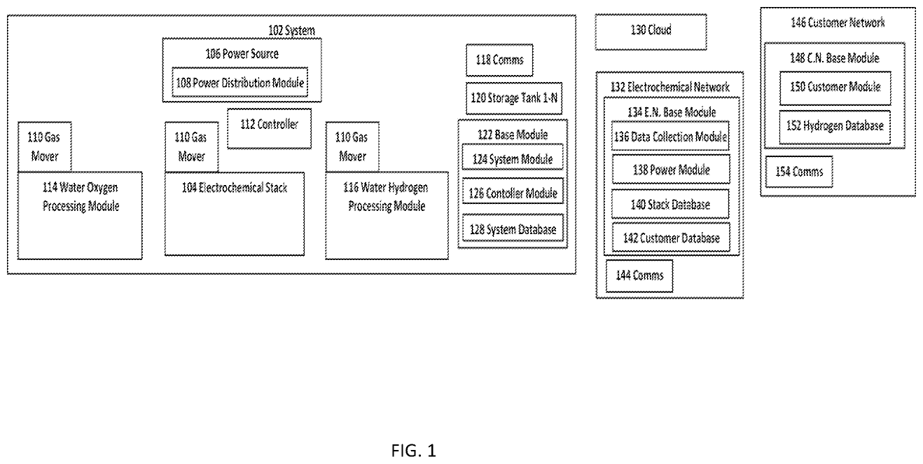

FIG. 1 is a block diagram a hydrogen generation system 102. The system 102 includes at least one cabinet defining a water oxygen processing module 114, an electrochemical stack 104, and a water hydrogen processing module 116 (the water oxygen processing module 114, the electrochemical stack 104, and the water hydrogen processing module 116 being fluidically isolated from each other), a water circuit located in the water oxygen processing module 114, an electrochemical module including an electrolyzer electrochemical stack located in the electrochemical stack 104, a hydrogen circuit located in the water hydrogen processing module 116, at least one first fluid connector fluidly connecting the water circuit and the electrolyzer electrochemical stack, and at least one second fluid connector fluidly connecting the electrolyzer electrochemical stack and the hydrogen circuit. The system 102 may also include a power source 106, a plurality of gas movers 110, a controller 112, comms 118, and at least one storage tank 1-N 120.

The electrochemical stack 104 may include a first membrane electrode assembly (MEA), a second membrane electrode assembly (MEA), and a bipolar plate that collectively defines two complete electrochemical cells for hydrogen generation. The electrochemical stack 104 may also include a first end plate and a second end plate that may sandwich the first MEA, the second MEA, and the bipolar plate into contact with one another and direct the flow of fluids into and out of the electrochemical stack 104. While the electrochemical stack 104 is described as including two complete cells—a single bipolar plate and two MEAs—it shall be appreciated that this is for the sake of clarity of explanation only. The electrochemical stack 104 may include any number of MEAs and bipolar plates useful for meeting the hydrogen generation demands of the system 102 while maintaining separation between pressurized hydrogen and lower pressure water and oxygen flowing through the electrochemical stack 104. Unless otherwise specified or made clear from the context, the electrochemical stack 104 may include more than one bipolar plate, a single MEA, and/or more than two MEAs. In some embodiments, an instance of the bipolar plate may be disposed between the first end plate and the first MEA and/or between the second end plate and the second MEA without departing from the scope of the present disclosure.

In general, the first MEA and the second MEA may be identical to one another. For example, the first MEA may include an anode, a cathode, and a proton exchange membrane (e.g., a PEM electrolyte) a therebetween. Similarly, the second MEA may include an anode, a cathode, and a proton exchange membrane therebetween. The anodes may each comprise an anode catalyst (i.e., electrode) contacting the membrane and an optional anode fluid diffusion layer. The cathodes may each comprise a cathode catalyst (i.e., electrode) contacting the membrane and an optional cathode gas diffusion layer. The anode electrode may comprise any suitable anode catalyst, such as an iridium layer. The anode fluid diffusion layer may comprise a porous material, mesh, or weave, such as a porous titanium sheet or a porous carbon sheet. The cathode electrode may comprise any suitable cathode catalyst, such as a platinum layer. The cathode gas diffusion layer may comprise porous carbon. Other noble metal catalyst layers may also be used for the anode and/or cathode electrodes. The electrolyte may comprise any suitable proton exchange (e.g., hydrogen ion transport) polymer membrane, such as a Nafion® membrane composed of sulfonated tetrafluoroethylene-based fluoropolymer-copolymer with a formula C₇HF₁₃O₅S·C₂F₄.

The bipolar plate may be disposed between the cathode of the first MEA and the anode of the second MEA. In general, the bipolar plate may include a substrate, an anode gasket, and a cathode gasket. The substrate has an anode (i.e., water) side and a cathode (i.e., hydrogen) side opposite one another. The anode gasket may be fixed to the anode side of the substrate, and the cathode gasket may be fixed to the cathode side of the substrate. Such fixed positioning of the anode gasket and the cathode gasket on opposite sides of the substrate may facilitate forming two seals that are consistently placed relative to one another and relative to the first MEA and the second MEA on either side of the bipolar plate. The gaskets form a double seal around the active areas, i.e., anode (e.g., water) flow field and cathode (e.g., hydrogen) flow field, located on respective opposite sides of the bipolar plate. Further, or instead, in instances in which an electrochemical stack 104 includes an instance of an MEA between two instances of the bipolar plate, the anode gasket and the cathode gasket may form a double seal along an active area of the MEA. Thus, more generally, the anode gasket and the cathode gasket may form a sealing engagement with one or more MEAs in an electrochemical stack to isolate flows within the electrode stack and, thus, reduce the likelihood that pressurized hydrogen may inadvertently mix with a flow of water and oxygen exiting the electrochemical stack to create a combustible hydrogen-oxygen mixture in the system 102.

The substrate may be formed of any one or more of various different types of materials that are electrically conductive, thermally conductive, and have strength suitable for withstanding the high pressure of hydrogen flowing along the cathode side of the substrate during use. Thus, for example, the substrate may be at least partially formed of one or more of plasticized graphite or carbon composite. Further, or instead, the substrate may be advantageously formed of one or more materials suitable for withstanding prolonged exposure to water on the anode side of the substrate. Accordingly, in some instances, the anode side of the substrate may include an oxidation inhibitor coating that is electrically conductive, examples of which include titanium, titanium oxide, titanium nitride, or a combination thereof. The oxidation inhibitor may generally extend at least along those portions of the anode side of the substrate exposed to water during the operation of the electrochemical stack 104. That is, the oxidation inhibitor may extend at least along the anode flow field inside the anode gasket on the anode side of the substrate. In some implementations, the oxide inhibitor may extend along the plurality of anode ports (i.e., water riser openings) which extend from the anode side to the cathode side of the substrate. The oxidation inhibitor may also be located in the anode plenums, which connect the anode portions to the anode flow field on the anode side of the substrate.

A cathode ring seal may be located around each cathode port (i.e., hydrogen riser opening) on the anode side of the substrate. The cathode ring seal prevents hydrogen from leaking out into the anode flow field on the anode side of the substrate. In contrast, an anode ring seal may be located around each one or more anode ports on the cathode side of the substrate. For example, two anode ports are surrounded by a common anode ring seal to prevent water from flowing into the cathode flow field on the cathode side of the substrate.

The anode flow field includes a plurality of straight and/or curved ribs separated by flow channels oriented to direct a liquid (e.g., purified water) between at least some of the plurality of anode ports, such as may be useful for evenly distributing purified water along the anode of the second MEA. The anode gasket may circumscribe the anode flow field and the plurality of anode ports along the anode side of the substrate to limit the movement of purified water moving along the anode. That is, the anode side of the substrate may be in sealed engagement with the anode of the second MEA via the anode gasket, such that anode channels are located therebetween. Under pressure provided by a source external to the electrochemical stack 104 (e.g., such as the pump of the water circuit), a liquid provided from the first fluid connector flows along the anode channels is directed across the anode of the second MEA, from one instance of the plurality of anode ports to another instance of the plurality of anode ports, where the liquid (e.g., remaining water and oxygen) may be directed out of the electrochemical stack 104 through another first fluid connector.

Additionally, the substrate may include a plurality of cathode ports (i.e., hydrogen riser openings), each extending from the anode side to the cathode side of the substrate. The cathode side of the substrate may include a cathode flow field. The cathode flow field includes a plurality of straight and/or curved ribs separated by cathode flow channels oriented to direct gas (e.g., hydrogen) toward the plurality of cathode ports, such as may be useful for directing pressurized hydrogen formed along the cathode of the first MEA. Cathode plenums may be located between the respective cathode ports and the cathode flow field. The cathode gasket may circumscribe the cathode flow field, the cathode plenums, and the plurality of cathode ports along the cathode side of the substrate to limit the movement of the pressurized hydrogen along the cathode. For example, the cathode side of the substrate may be in sealed engagement with the cathode of the first MEA via the cathode gasket, such that the cathode flow channels are defined between the cathode of the first MEA and the cathode side of the substrate. The pressure of the hydrogen formed along the cathode may move the hydrogen along at least a portion of the cathode channels and toward the cathode ports located diagonally opposite the cathode inlet port. The pressurized hydrogen may flow out of the cathode ports and out of the electrochemical stack 104 through the second fluid connector to be processed by the hydrogen circuit.

The anode gasket on the anode side of the substrate and the cathode gasket on the cathode side of the substrate may have different shapes. For example, the anode gasket may extend between the plurality of anode ports and the plurality of cathode ports on the anode side of the substrate. In other words, the anode gasket surrounds the anode ports and the anode flow field on one lateral side but leaves the cathode portions outside its circumscribed area. Therefore, the anode gasket may fluidically isolate anode flow from cathode flow in an installed position.

In contrast, the cathode gasket on the cathode side of the substrate does not extend between the plurality of anode ports and the plurality of cathode ports. In other words, the cathode gasket surrounds the anode ports, the cathode portions, and the cathode flow field. Instead, the anode ring seals isolate the anode portions from the cathode ports and the cathode flow field on the cathode side of the substrate.

In one configuration, the anode flow field and the cathode flow field may have the same shape, albeit on the opposite side of the substrate, to provide the same active area along the first MEA and the second MEA. Thus, taken together, the differences in shape between the anode gasket and the cathode gasket, along with the positioning of the anode ring seals and the same shape of the anode flow field and the cathode flow field, may result in different sealed areas. These different sealed areas are complementary to one another to facilitate fluidically isolating the lower pressure flow of purified water along the anode channels from the pressurized hydrogen flowing along the cathode channels while nevertheless allowing each flow to move through the electrochemical stack 104 and ultimately exit the electrochemical stack 104 along different channels.

In certain implementations, the cathode flow field may be shaped such that a minimum bounding rectangle of the cathode flow field is square. As used in this context, the term minimum bounding rectangle shall be understood to be a minimum rectangle defined by the maximum x- and y-dimensions of the cathode flow field. The plurality of cathode ports may include two cathode ports per substrate which are located at diagonally opposite corners from one another with respect to the minimum bounding rectangle (e.g., within the minimum bounding rectangle). The other two diagonally opposite corners lack the cathode ports. In instances in which the minimum bounding rectangle is square, the diagonal positioning of the cathode ports relative to the minimum bounding rectangle may facilitate the flow of pressurized hydrogen diagonally along the entire cathode flow field while leaving a large margin of the substrate material for strengths against the contained internal hydrogen pressure. Alternatively, the substrate may be a rectangle. The plurality of cathode ports are positioned away from the edges of the substrate such that each one of the plurality of cathode ports is well-reinforced by the material of the substrate between the respective one of the plurality of cathode ports and the closest edge of the substrate.

Given the large pressure differential between the flow of pressurized hydrogen along the cathode channels and the flow of water and oxygen along the anode channels, the electrochemical stack 104 may include the anode fluid diffusion layer disposed in the anode channels and optionally between the anode electrode of the anode of the second MEA and the anode side (e.g., anode ribs) of the substrate. The porous material of the anode fluid diffusion layer may generally permit the flow of water and oxygen through the anode channels without a substantial increase in flow restriction through the anode channels while providing structural support on the anode side of the substrate to resist collapse that may result from the pressure difference on opposite sides of the substrate. For the sake of clear illustration, the porous material is shown along only one anode channel. It shall be understood, however, the that porous material may be disposed inside all of the anode channels in certain implementations.

As an additional, or alternative, safety measure, the electrochemical stack 104 may include a housing disposed about the first MEA, the second MEA, the bipolar plate, the first end plate, and the second end plate. More specifically, the housing may be formed of one or more materials useful for absorbing the force of one or more materials that may become ejected in the event of a failure event (e.g., failure under the force of pressurized hydrogen and/or failure resulting from an explosion of an inadvertent hydrogen-containing mixture). For example, the housing may include one or more metal or aramid (e.g., Kevlar®) fibers.

Having described various features of the electrochemical stack 104, attention is now directed to a description of the operation of the electrochemical stack 104 to form pressurized hydrogen with water and electricity as inputs. In particular, an electric field E (i.e., voltage) may be applied across the electrochemical stack 104 (i.e., between the end plates) from the power source 106. The bipolar plate may electrically connect the first MEA and the second MEA in series with one another such that electrolysis may take place at the first MEA and the second MEA to form a flow of pressurized hydrogen that is maintained fluidically isolated from lower pressure water and oxygen, except for proton exchange occurring through the proton exchange membrane and the proton exchange membrane.

Purified water (e.g., from the water circuit) may be introduced into the electrochemical stack 104 via the first fluid connector of the system 102. Within the electrochemical stack 104, the purified water may flow along an intake channel that extends through the bipolar plate, among other components, to direct the purified water to the anode of the first MEA and to the anode of the second MEA. With the electric field E applied across the anode and the cathode of the first MEA, the purified water may break down along the anode into protons (H⁺) and oxygen. The protons (H⁺) may move from the anode to the cathode through the proton exchange membrane. At the cathode, the protons (H⁺) may combine with one another to form pressurized hydrogen along the cathode. Through an analogous process, pressurized hydrogen may also be formed along the cathode of the second MEA. The flows of pressurized hydrogen formed by each of the first MEA and the second MEA may combine with one another and flow out of the electrochemical stack 104 via two hydrogen exhaust channels that extend through the bipolar plate, among other components, to ultimately direct the pressurized hydrogen out of the second fluid connector of the system 102 and toward the hydrogen circuit for processing. The flows of oxygen and water along the first anode and the second anode may combine with one another and flow out of the electrochemical stack 104 via the outlet anode ports and an outlet channel that extends through the end plate, among other components, to direct this stream of water and oxygen out of the first fluid connector of the system 102 and toward the water circuit for processing.

As discussed above, the bipolar plate may be in sealed engagement with the cathode of the first MEA and the anode of the second MEA to facilitate keeping pressurized hydrogen formed along the cathode of the first MEA separate from water and oxygen flowing along the anode of the second MEA. This separation is useful for reducing the likelihood of leakage of pressurized hydrogen from the electrochemical stack 104 and, thus, may be useful in addition to, or instead of, any one or more aspects of the modularity of the system 102 with respect to safely producing industrial-scale quantities of hydrogen through electrolysis. Additionally, or alternatively, the sealed engagement facilitated by the bipolar plate may facilitate dismantling the system 102 (e.g., to repair, maintain, and/or replace the electrochemical stack 104) with a lower likelihood of spilling water in the vicinity of the cabinet. 104.

Further, embodiments may include a power source 106, which may include AC energy resources, such as the power grid, wind turbines, solar farms, energy storage, and conventional energy resources, such as nuclear power stations, gas power plants, etc. Also, the power source 106 may include DC energy resources, such as wind turbines, solar photovoltaic arrays, energy store, DC power grids, etc. 106.

Further, embodiments may include a power distribution module 108, which is an architecture of the current embodiment and may include a substation, a plurality of transformers, transformer load break switch, a plurality of power converters (e.g., rectifiers, inverters, etc.), and a plurality of electrochemical stacks. The power distribution module 108 depicts how the current from the substation is provided to the selected transformer and how the transformer provides a current to the selected power converter and how the power converter provides power to the selected electrochemical stack 104 in order to produce the hydrogen requested from the customer. 108.

Further, embodiments may include a plurality of gas movers 110 (referred to collectively as the plurality of gas movers 110 and individually as the first gas mover 110, the second gas mover 110, and the third gas mover 110). The plurality of gas movers 110 may include any one or more of various different types of fans (e.g., purge fans), blowers, or compressors unless otherwise specified or made clear from the context. In certain implementations, a powered circuit to each one of the plurality of gas movers 110 may be rated for Class 1 Division 2 operation, as specified according to the National Fire Protection Association (NFPA) 70®, National Electric Code® (NEC), Articles 500-503, 2020, the entire contents of which are incorporated herein by reference. In such implementations, each one of the plurality of gas movers 110 may be disposed within the cabinet. Alternatively, each one of the plurality of gas movers 110 may be mounted externally to the cabinet (e.g., to the roof or sidewall of the cabinet) to reduce the potential for heat or sparks to act as an inadvertent ignition source for contents of the first volume, the second volume, or the third volume.

In general, the first gas mover 110 may be in fluid communication with the first volume, the second gas mover 110 may be in fluid communication with the second volume, and the third gas mover 110 may be in fluid communication with the third volume. For example, each one of the plurality of gas movers 110 may be in fluid communication between an environment outside of the cabinet and a corresponding one of the first volume, the second volume, and the third volume and may be configured to separately ventilate the respective volume of the cabinet. Additionally, or alternatively, each of the plurality of gas movers 110 may be operable to form negative pressure in a corresponding one of the first volume, the second volume, and the third volume, relative to the environment outside of the cabinet. Such negative pressure may be useful, for example, for drawing air from the environment into the first volume, the second volume, and the third volume to reduce the likelihood that any hydrogen leaking into the first volume, the second volume, or the third volume may accumulate in a concentration above the lower ignition limit of a hydrogen-air mixture at the temperature and pressure associated with the cabinet. Further, negative pressure in the first, second, and third volumes may reduce the likelihood that an ignitable, hydrogen-containing mixture may escape from the cabinet. In certain instances, the cabinet may be insulated to facilitate maintaining one or more components in the first volume, the second volume, and the third volume within a temperature range (e.g., between about 60° C. and about 80° C.) suitable for operation of the electrochemical stack 104.

While the plurality of gas movers 110 may be useful for reducing the likelihood of unsafe conditions forming in the first volume, the second volume, or the third volume, one or more of these volumes may additionally, or alternatively, include area classified components. In such instances, the corresponding volume may be unventilated.

Further, embodiments may include a controller 112, which is in electrical communication at least with one or more components in the first volume, the second volume, or the third volume. In general, the controller 112 may include one or more processors and a non-transitory computer-readable storage medium having stored thereon instructions for causing the one or more processors to control one or more of the startup, operation, or shutdown of any one or more of various aspects of the system 102 to facilitate safe and efficient operation. For example, the controller 112 may include one or more embedded controllers for one or more components in the first volume, the second volume, or the third volume. Additionally, or alternatively, the controller 112 may be in electrical communication at least with the electrochemical stack 104 and a power source 106. Continuing with this example, the controller 112 may interrupt power to the electrochemical stack 104 in the event that an anomalous condition is detected. Further, or instead, the controller 112 may provide power to the electrochemical stack 104 after a startup protocol (e.g., purging the first volume, the second volume, and or the third volume) to reduce the likelihood of igniting a hydrogen-containing mixture in the cabinet.

In some implementations, the cabinet may define a fourth volume, and the controller 112 may be disposed in the fourth volume while being in wireless or wired communication with one or more of the various different components described herein as being disposed in one or more of the first volume, the second volume, or the third volume. The fourth volume may be generally located in the vicinity of the first volume, the second volume, and the third volume to facilitate making and/or breaking electrical connections as part of one or more of installation, startup, regular operation, maintenance, or repair. Thus, for example, the fourth volume may be disposed along a top portion of the cabinet and/or along a back portion of the cabinet, with both locations providing useful access to each of the first volume, the second volume, and the third volume while being away from the first door, the second door, and the third door that may be used to provide access to the first volume, the second volume, and the third volume, respectively. Further, or instead, with the controller 112 disposed therein, the fourth volume may be fluidically isolated from each of the first volume, the second volume, and/or the third volume by a roof or back wall of the cabinet to reduce the likelihood of exposing the controller 112 to one or more process fluids during installation, startup, regular operation, shutdown, maintenance, or repair that may compromise the operation of the controller 112.

While the first volume, the second volume, and the third volume have been described as having a negative pressure provided by the plurality of gas movers, the fourth volume may be in fluid communication with a fan operable to generate positive pressure in the fourth volume, relative to an environment outside of the fourth volume, to control the temperature of the controller 112 and/or other components within the fourth volume. Further, or instead, while the fourth volume has been described as housing the controller 112, the fourth volume may house all controls and power electronics for the system 102, as it may be useful for reducing the likelihood that inadvertent sparking or overheating of one or more of such components can ignite a hydrogen-containing mixture in one or more of the first volume, the second volume, or the third volume.

In certain implementations, the controller 112 may further, or instead, monitor one or more ambient conditions in the first volume, the second volume, and the third volume to facilitate taking one or more remedial actions before an anomalous condition results in damage to the system 102 and/or to an area near the system 102. In particular, given the potential damage that may be caused by the presence of an ignitable hydrogen-containing mixture within the cabinet, the system 102 may include a plurality of gas sensors (referred to collectively as the plurality of gas sensors and individually as the first gas sensor, second gas sensor, or third gas sensor). Each one of the plurality of gas sensors may include any one or more of various different types of hydrogen sensors, such as one or more of optical fiber sensors, electrochemical hydrogen sensors, thin-film sensors, and the like. To facilitate robust detection of hydrogen within the cabinet, the first gas sensor may be disposed in the first volume, the second gas sensor may be disposed in the second volume, and the third gas sensor may be disposed in the third volume. Each one of the plurality of gas sensors may be calibrated to detect hydrogen concentration levels below the ignition limit of hydrogen to facilitate taking remedial action before an ignition event can occur. Toward this end, the controller 112 may be in electrical communication with each one of the plurality of gas sensors. The non-transitory computer-readable storage media of the controller 112 may have stored thereon instructions for causing one or more processors of the controller 112 to interrupt electrical communication between the power source 106 and equipment in the cabinet based on a signal, received from one or more of the plurality of gas sensors and indicative of a dangerous hydrogen concentration. Additionally, or alternatively, the signal received from one or more of the plurality of gas sensors may be indicative of a rapid increase in hydrogen concentration.

While the controller 112 may be useful for taking remedial action with respect to potentially hazardous conditions in the cabinet, the system 102 may additionally, or alternatively, include one or more safety features useful for mitigating damage to the system 102 and/or in the vicinity of the system in the event of an explosion. For example, the system 102 may include a pressure relief valve in fluid communication with at least the third volume of the cabinet. The pressure relief valve may be a mechanical valve that is self-opening at a predetermined threshold pressure in the third volume. In some instances, the predetermined threshold pressure may be a pressure increase resulting from leakage of pressurized hydrogen into the third volume. Alternatively, the predetermined threshold pressure may be a high pressure associated with a rapid pressure rise associated with the combustion of hydrogen-containing mixtures. In each case, the pressure relief valve may vent contents of the third volume to the environment to mitigate damage that may otherwise occur.

Further, embodiments may include a water oxygen processing module 114, which includes a water circuit, separator, reservoir, pump, a gas mover 110, and a gas sensor. In general, the water circuit may optionally include a reservoir (e.g., a water tank) in fluid communication between a separator and a pump via respective fluid conduits. In certain implementations, the reservoir may be coupled to an external water source (e.g., water pipe, not shown) to receive a water supply suitable for meeting the demands of the electrochemical stack 104. The connection between the reservoir and the external water source may be made outside of the cabinet to facilitate connection of the system 102 to an industrial water supply and, in some instances, to reduce the likelihood of damaging equipment in one or more of the first volume, the second volume, or the third volume in the event of a leak in the connection between the external water source and the reservoir. The water circuit may include any of the various different types of equipment useful for managing the properties of the water flowing through the system 102. For example, the water circuit may include filtration or other processing equipment useful for the purification of process water to reduce the concentration of contaminants that may degrade the performance of other components (e.g., the electrochemical stack 104) over time. Additionally, or alternatively, the water circuit may include a heat exchanger (not shown) in thermal communication with one or more of the reservoir, the separator, or the pump to manage the temperature of each component and/or manage the temperature of water flowing through each component.

The pump may be in fluid communication with the electrochemical stack 104 via a feed conduit extending from the pump in the first volume to the first fluid connector of the system 102. The feed conduit may extend through the wall between the first and second volumes. The pump may be powered to move purified water from the reservoir along the feed conduit extending from the first volume to the second volume and into the electrochemical stack 104 in the second volume. Thus, the pump may be operable to deliver purified water to the second volume while being partitioned from equipment in each second and third volumes. Such partitioning of the pump may be advantageous for, among other things, reducing the likelihood that heat generated by the pump during operation may serve as an ignition source for a hydrogen-containing mixture. For example, in the event of a hydrogen leak in the second and/or third volumes, an ignitable hydrogen-air mixture may inadvertently form in the second and/or third volumes. Continuing with this example, keeping the pump partitioned away from the second volume and the third volume may, therefore, reduce the likelihood that ignition can occur before the ignitable hydrogen-air mixture can be detected and the system safely shut down.

In some implementations, the water circuit may include a recirculation circuit in fluid communication between the first fluid connector and the separator. Through the fluid communication with the first fluid connector, the recirculation circuit may receive an exit flow consisting essentially of water and oxygen from the anode portion of the electrochemical stack 104. At least a portion of the recirculation circuit may extend from the second volume to the first volume through the wall to direct the flow of water and oxygen from the electrochemical stack 104 in the second volume to the separator in the first volume. By carrying oxygen to the separator in the first volume partitioned from the second volume, the recirculation circuit may reduce the likelihood that oxygen in the excess water flowing from the system 102 may inadvertently escape into the second volume and/or the third volume to form an ignitable mixture with hydrogen.

The separator may be any one or more of various different types of gas-liquid separators suitable for separating oxygen from excess water in the return flow moving through the recirculation circuit from the system 102. For example, the separator may comprise a dryer, a condenser, or another device that separates oxygen from excess water through gravity. The excess water settles along the bottom portion of the separator, and oxygen collects along the top portion of the separator. More generally, the separator may operate to separate oxygen from excess water without the use of power or moving parts that could otherwise act as potential ignition sources in the system 102. The oxygen collected by the separator may be directed out of the first volume to be vented to an environment outside of the cabinet or to be used as a process gas for another part of a plant. By way of example and not limitation, the oxygen collected by the separator may be removed from the separator using a suction pump or blower. The excess water collected by the separator may be directed to the reservoir to be circulated through the electrochemical stack 104 again. That is, more generally, the separator may remove oxygen from the cabinet at a position away from hydrogen-related equipment in the second volume and the third volume while facilitating efficient use of water in the formation of hydrogen.

Further, embodiments may include a water hydrogen processing module 116, which includes a hydrogen circuit, a dryer, and a hydrogen pump. The hydrogen circuit may include a product conduit and a dryer in fluid communication with one another. More specifically, the product conduit may extend through the wall between the second volume and the third volume. The product conduit may be in fluid communication between the inlet portion of the dryer and the second fluid connector of the system 102. Thus, in use, a product stream consisting essentially of hydrogen and water (e.g., water vapor) may move from the anode side of the electrochemical stack 104 to the inlet portion of the dryer via the second fluid connector and the product conduit. As compared to the mixture of oxygen and excess water in the exit flow from the anode portion of the electrochemical stack 104 into the recirculation circuit, the product stream may be at a higher pressure. To reduce the likelihood of hydrogen leaking into the third volume, the connections between the product conduit and each of the second fluid connector and the dryer may include gas-tight seals.

The dryer may be, for example, pressure swing adsorption (PSA), a temperature swing adsorption (TSA) system, or a hybrid PSA-TSA system. The dryer may include one or more beds of a water-adsorbent material, such as activated carbon, silica, zeolite, or alumina. As the product mixture consisting essentially of hydrogen and water moves through from the inlet portion to an outlet portion of the dryer, at least a portion of the water may be removed from the product mixture through adsorption of either water or hydrogen in the bed of water-adsorbent material. If hydrogen is adsorbed, then it is removed into the outlet conduit during a pressure and/or temperature swing cycle. If water is adsorbed, then it is removed into a pump conduit during the pressure and/or temperature swing cycle. In some instances, adsorption carried out by the dryer may be passive, without the addition of heat or electricity that could otherwise act as ignition sources of an ignitable hydrogen-containing mixture. In such instances, however, considerations related to backpressure created by the dryer in fluid communication with the electrochemical stack 104 may limit the size and, therefore, the single-pass effectiveness of the dryer in removing moisture from the product stream.

At least in view of such considerations related to the single-pass effectiveness of the dryer, the hydrogen circuit may further, or instead, include a hydrogen pump in fluid communication between the outlet portion and the inlet portion of the dryer to recirculate the product mixture of hydrogen and water for additional passes through the dryer. For example, the dryer may direct dried hydrogen from the outlet portion of the dryer to an outlet conduit that directs the dried hydrogen to a downstream process or storage in an environment outside of the cabinet. Further, or instead, the dryer may direct a portion of the product stream that has not adequately dried from the outlet portion of the dryer to a pump conduit in fluid communication with the hydrogen pump. In certain instances, at least a portion of the water in the product mixture moving along the pump conduit may condense out of the product mixture and collect in a moisture trap in fluid communication with the pump conduit before reaching the hydrogen pump. Such moisture condensed in the moisture trap may be collected and/or directed to an environment outside of the cabinet.

The hydrogen pump may be, for example, an electrochemical pump. As used in this context, an electrochemical pump shall be understood to include a proton exchange membrane (i.e., a PEM electrolyte) disposed between an anode and a cathode. The hydrogen pump may generate protons moveable from the anode through the proton exchange membrane to the cathode form pressurized hydrogen. Thus, such an electrochemical pump may be particularly useful for recirculating hydrogen within the hydrogen circuit at least because the electrochemical pumping provided by the electrochemical pump separates hydrogen from water in the mixture delivered to the hydrogen pump via the pump conduit while also pressurizing the separated hydrogen to facilitate moving the pressurized hydrogen to the inlet portion of the dryer.

Alternatively, the hydrogen pump may comprise another hydrogen pumping and/or separation device, such as a diaphragm compressor or blower or a metal-hydride separator (e.g., which selectively adsorbs hydrogen) which may be used in combination with or instead of the electrochemical hydrogen pump. In one embodiment, a plurality of stages of hydrogen pumping and/or re-pressurization may be used. Each stage may comprise one or more of the diaphragm compressor or blower, the electrochemical pump, or the metal-hydride separator. In one implementation, the stages may be in a cascade (i.e., series) configuration and/or may be located in separate enclosures.

In certain implementations, the hydrogen pump may be in fluid communication with the moisture trap, where the water separated from hydrogen in the hydrogen pump may be collected and/or directed to an environment outside of the cabinet. Additionally, or alternatively, the pressurized hydrogen formed by the hydrogen pump may be directed along a recovery circuit in fluid communication between the hydrogen pump and the inlet portion of the dryer (e.g., via mixing with the product stream in the product conduit) to recirculate the pressurized hydrogen to the dryer. Among other advantages, recirculating the pressurized hydrogen through the dryer in this way facilitates moving hydrogen out of the cabinet through only a single conduit (e.g., the outlet conduit), which may reduce potential failure modes as compared to the use of multiple exit points.

Further, embodiments may include comms 118 or a communication network that may be wired and/or wireless. The comms 118, if wireless, may be implemented using various communication techniques, such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The comms 118 may allow ubiquitous access to shared pools of configurable system resources and higher-level services that can be rapidly provisioned with minimal management effort, often over the Internet, and relies on sharing of resources to achieve coherence and economies of scale, like a public utility, while third-party clouds enable organizations to focus on their core businesses instead of expending resources on computer infrastructure and maintenance.

Embodiments may also include one or up to N storage tanks 120, which may include a plurality of hydrogen storage tanks to contain the hydrogen created from the system 102. The storage tank 120 may be used to store excess hydrogen created by the system 102 to be used or shipped to users at a later time. The storage tank 120 may be used to contain hydrogen until shipped to users, such as industrial outputs, for example, refinery uses, iron or steel reduction uses, concrete production uses, ammonia synthesis uses, hydrogenated oils uses, other chemical plant type uses, etc.

In addition, embodiments may include a base module 122, which begins with the base module 122 initiating the system module 124. For example, the system module 124 may begin by being initiated by the base module 122. Then the system module 124 connects to the data collection module 136. Then the system module 124 is continuously polling for a request for the data stored in the system database 128 from the data collection module 136. The system module 124 receives the request from the data collection module 136 for the data stored in the system database 128. Then the system module 124 sends the data stored in the system database 128 to the data collection module 136. The system module 124 returns to the base module 122. Then the base module 122 initiates the controller module 126. For example, the controller module 126 may begin by being initiated by the base module 122. Then the controller module 126 connects to the power module 138. The controller module 126 is continuously polling for the power distribution data and the selected electrochemical stacks 104 from the power module 138. Then the controller module 126 receives the power distribution data and the selected electrochemical stacks 104 from the power module 138. The controller module 126 sends the power distribution data and the selected electrochemical stacks 104 to the controller 112. The controller module 126 returns to the base module 122.

Some embodiments may include a system module 124, which begins by being initiated by the base module 122. Then the system module 124 connects to the data collection module 136. Then the system module 124 is continuously polling for a request for the data stored in the system database 128 from the data collection module 136. The system module 124 receives the request from the data collection module 136 for the data stored in the system database 128. Then the system module 124 sends the data stored in the system database 128 to the data collection module 136. The system module 124 returns to the base module 122.

Embodiments may also include a controller module 126, which begins by being initiated by the base module 122. Then the controller module 126 connects to the power module 138. The controller module 126 continuously polls for the power distribution data and the selected electrochemical stacks 104 from the power module 138. Then the controller module 126 receives the power distribution data and the selected electrochemical stacks 104 from the power module 138. The controller module 126 sends the power distribution data and the selected electrochemical stacks 104 to the controller 112. The controller module 126 returns to the base module 122.

Certain embodiments may include a system database 128. The database may contain the power distribution data for each electrochemical stacks 104 within the system 102. The database contains the client's name, the electrochemical stack 104 number, the power converter number for the electrochemical stack 104, the transformer number for the power converter, the average rate of hydrogen production for the electrochemical stack 104, the water required for the electrochemical stack 104, and the status of the electrochemical stack 104. In some embodiments, the electrochemical stack 104, the power converter, and the transformer may have a specific identification, including a series of numbers, letters, characters, etc., to uniquely identify each component. In some embodiments, the transformers may send power to a plurality of power converters, and the power converters may power a plurality of electrochemical stacks 104.

In addition, embodiments may include a cloud 130 that may be a wired and/or a wireless network. The cloud 130, if wireless, may be implemented using communication techniques, such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The cloud 130 may allow ubiquitous access to shared pools of configurable system resources and higher-level services that can be rapidly provisioned with minimal management effort, often over the Internet, and relies on sharing of resources to achieve coherence and economies of scale, like a public utility. In contrast, third-party clouds enable organizations to focus on their core businesses instead of expending resources on computer infrastructure and maintenance.

Embodiments may also include an electrochemical network 132, which connects to the system 102, and the customer network 146, collects data from the system 102 and the customer network 146, and stores the collected data. In some embodiments, the electrochemical network 132 may determine cost-efficient times to produce hydrogen through a customer's system 102 and send a notification to the system 102 to generate hydrogen using the most cost-efficient power source.

Further, embodiments may include an E.N. base module 134, which begins by initiating the data collection module 136. For example, the data collection module 136 begins by being initiated by the E.N. base module 134. The data collection module 136 connects to the base module 122. Then the data collection module 136 sends a request to the base module 122 for the data stored in the system database 128. The data collection module 136 is continuously polling to receive the data stored in the system database 128 from the base module 122. The data collection module 136 receives the data stored in the system database 128 from the base module 122. Then the data collection module 136 stores the received data in the stack database 140. The data collection module 136 connects to the customer module 150. Then the data collection module 136 sends a request to the customer module 150 for the data stored in the hydrogen database 152. The data collection module 136 is continuously polling to receive the data stored in the hydrogen database 152 from the customer module 150. The data collection module 136 receives the data stored in the hydrogen database 152 from the customer module 150. Then the data collection module 136 stores the received data in the customer database 142. The data collection module 136 returns to the E.N. base module 134. Then the E.N. base module 134 initiates the power module 138. For example, the power module 138 begins by being initiated by the E.N. base module 134. The power module 138 extracts the hydrogen request from the customer database 142. Then the power module 138 determines the number of electrochemical stacks 104 needed to meet the customer's hydrogen request. The power module 138 filters the stack database 140 on the client's name. Then the power module 138 filters the stack database 140 on the active electrochemical stacks 104. The power module 138 selects the electrochemical stacks 104 needed to meet the customer's hydrogen request. For example, the power distribution module 108 may select the electrochemical stacks based on which electrochemical stacks of the plurality of electrochemical stacks are active and the rate of hydrogen production for each active electrochemical stack of the plurality of electrochemical stacks. The power module 138 extracts the power distribution data for the selected electrochemical stacks 104. The power module 138 connects to the controller module 126. The power module 138 sends the extracted power distribution data and the selected electrochemical stacks 104 to the controller module 126. The power module 138 returns to the E.N. base module 134.

Additionally, embodiments may include a data collection module 136, which begins by being initiated by the E.N. base module 134. The data collection module 136 connects to the base module 122. Then the data collection module 136 sends a request to the base module 122 for the data stored in the system database 128. The data collection module 136 is continuously polling to receive the data stored in the system database 128 from the base module 122. The data collection module 136 receives the data stored in the system database 128 from the base module 122. Then the data collection module 136 stores the received data in the stack database 140. The data collection module 136 connects to the customer module 150. Then the data collection module 136 sends a request to the customer module 150 for the data stored in the hydrogen database 152. The data collection module 136 is continuously polling to receive the data stored in the hydrogen database 152 from the customer module 150. The data collection module 136 receives the data stored in the hydrogen database 152 from the customer module 150. Then the data collection module 136 stores the received data in the customer database 142. The data collection module 136 returns to the E.N. base module 134.

Some embodiments may further include a power module 138, which begins by being initiated by the E.N. base module 134. The power module 138 extracts the hydrogen request from the customer database 142. Then the power module 138 determines the number of electrochemical stacks 104 needed to meet the customer's hydrogen request. The power module 138 filters the stack database 140 on the client's name. Then the power module 138 filters the stack database 140 on the active electrochemical stacks 104. The power module 138 selects the electrochemical stacks 104 needed to meet the customer's hydrogen request. The power module 138 extracts the power distribution data for the selected electrochemical stacks 104. The power module 138 connects to the controller module 126. The power module 138 sends the extracted power distribution data and the selected electrochemical stacks 104 to the controller module 126. The power module 138 returns to the E.N. base module 134.

Embodiments may also include a stack database 140. The database contains the power distribution data for each of the electrochemical stacks 104 within each client's the system 102. The database contains the client's name, the electrochemical stack 104 number, the power converter number for the electrochemical stack 104, the transformer number for the power converter, the average rate of hydrogen production for the electrochemical stack 104, the water required for the electrochemical stack 104, and the status of the electrochemical stack 104. In some embodiments, the electrochemical stack 104, the power converter, and the transformer may have a specific identification, including a series of numbers, letters, characters, etc., to uniquely identify each component. In some embodiments, the transformers may send power to a plurality of power converters, and the power converters may power a plurality of electrochemical stacks 104.

In addition, embodiments may include a customer database 142, which contains the customer's name, such as client 1, the total number of electrochemical stacks 104 the client has within their system 102, the number of electrochemical stacks needed to complete the hydrogen request, the hydrogen request, such as 600 kg of hydrogen, the amount of hydrogen generated, the date and the time. In some embodiments, the database may contain a customer ID, the customer's location, the number of active electrochemical stacks, and the number of electrochemical stacks not active. In some embodiments, the hydrogen request may be daily, hourly, weekly, monthly, quarterly, yearly, etc. In some embodiments, the user may not have to input the hydrogen request, such as having an automated system that may determine the hydrogen request by reading a database of the customer's orders, required shipments, etc. In some embodiments, the database may contain the amount of hydrogen stored in the storage tanks 120 if additional hydrogen was produced. For example, if a renewable energy source was used for hydrogen production at a lower cost, the system 102 may generate additional hydrogen since it is cheaper to produce using an energy source that has a lower cost than the grid energy source.

In some embodiments, embodiments may include comms 144, that may be a wired and/or a wireless network. The comms 144 or communication network, if wireless, may be implemented using communication techniques, such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The comms 144 may allow ubiquitous access to shared pools of configurable system resources and higher-level services that can be rapidly provisioned with minimal management effort, often over the Internet, and relies on sharing of resources to achieve coherence and economies of scale, like a public utility, while third-party clouds enable organizations to focus on their core businesses instead of expending resources on computer infrastructure and maintenance.

Embodiments may also include a customer network 146, which allows the users or customers to input their hydrogen requests to the system 102 through the C.N. base module 148. The customer network 146 allows the customers or users to share information or data with the system 102 and electrochemical network 132.

Embodiments may further include a C.N. base module 148, which begins by continuously polling for the user input. Then the user inputs the hydrogen request. The C.N. base module 148 stores the hydrogen request in the hydrogen database 152. Then the C.N. base module 148 initiates the customer module 150. For example, the customer module 150 begins by being initiated by the C.N. base module 148. Then the customer module 150 is continuously polling for a request from the data collection module 136 for the data stored in the hydrogen database 152. The customer module 150 receives a request for the data stored in the hydrogen database 152 from the data collection module 136. Then the customer module 150 sends the data stored in the hydrogen database 152 to the data collection module 136. The customer module 150 returns to the C.N. base module 148.

In addition, embodiments may include a customer module 150, which begins by being initiated by the C.N. base module 148. Then the customer module 150 is continuously polling for a request from the data collection module 136 for the data stored in the hydrogen database 152. The customer module 150 receives a request for the data stored in the hydrogen database 152 from the data collection module 136. Then the customer module 150 sends the data stored in the hydrogen database 152 to the data collection module 136. The customer module 150 returns to the C.N. base module 148.

Furthermore, embodiments may include a hydrogen database 152, which may contain the customer's name, such as client 1, the total number of electrochemical stacks 104 the client has within their system 102, the hydrogen request, such as 600 kg of hydrogen, the number of electrochemical stacks needed to complete the hydrogen request, the date, and the time. In some embodiments, the database may contain a customer ID, the customer's location, the number of active electrochemical stacks, and the number of electrochemical stacks not active. In some embodiments, the hydrogen request may be daily, hourly, weekly, monthly, quarterly, yearly, etc. In some embodiments, the user may not have to input the hydrogen request, such as having an automated system that may determine the hydrogen request by reading a database of the customer's orders, required shipments, etc.

In addition, embodiments may include comms 154 may be a wired and/or a wireless network. The comms 154, if wireless, may be implemented using communication techniques, such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The comms 154 may allow ubiquitous access to shared pools of configurable system resources and higher-level services that can be rapidly provisioned with minimal management effort, often over the Internet, and relies on sharing of resources to achieve coherence and economies of scale, like a public utility, while third-party clouds enable organizations to focus on their core businesses instead of expending resources on computer infrastructure and maintenance.

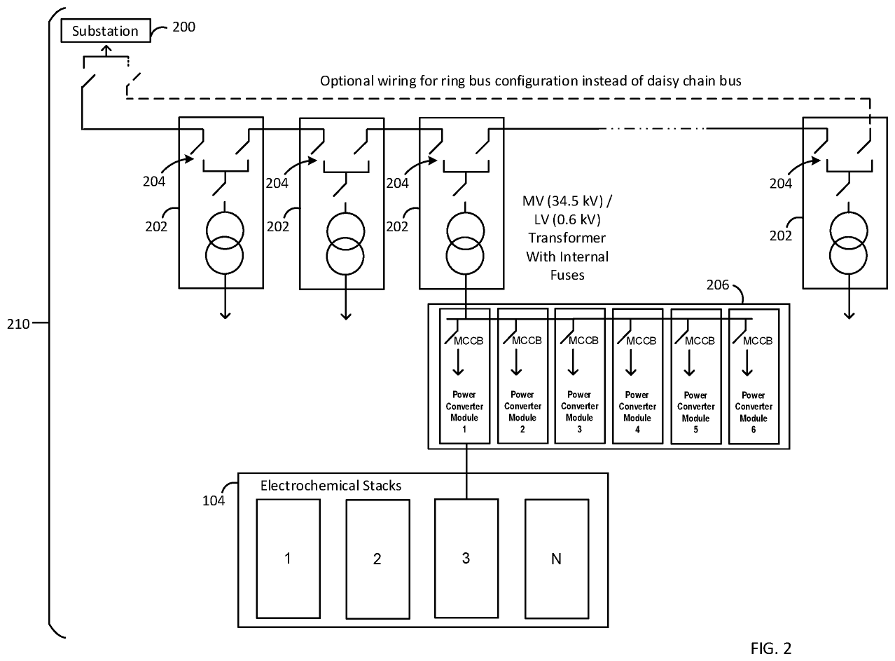

FIG. 2 is a schematic diagram providing additional details of the power distribution module 108 and associated components. The substation 200 may be a set of equipment reducing the high voltage of electrical power transmissions to that suitable for supply to consumers. The substation 200 may lower the voltage electricity from the high voltage electricity from the transmission system to the lower voltage electricity so it can be easily supplied to the system 102. The substation 200 may contain switching, protection and control equipment, transformers, etc. A transformer 202 may be an apparatus for reducing or increasing the voltage of an alternating current and is a passive component that transfers electrical energy from one electrical circuit to another or multiple circuits. Varying current in any coil of the transformer produces a varying magnetic flux in the transformer's core, which induces a varying electromotive force across any coils wound around the same core. Electrical energy can be transferred between separate coils without a metallic (conductive) connection between the two circuits. Transformers 202 are used to change AC voltage levels, such transformers 202 being termed step-up (or step-down) type to increase (or decrease) voltage level. Transformers 202 can also be used to provide galvanic isolation between circuits as well as to couple stages of signal-processing circuits.

As illustrated, the transformers 202 may receive an alternating current from the substation 200 and may transfer the alternating current to a power converter 206, such as a rectifier. The power converter 206 may also include an inverter for cases in which power is delivered back to the grid. In some embodiments, a plurality of transformers 202 may transfer the electrical current to the plurality of power converters 206, which then provide power to a plurality of electrochemical stacks 104. In some embodiments, the power is distributed to distribution transformers 202 at a higher voltage to reduce the cost of cables. In some embodiments, the transformers 202 are arranged in a daisy chain or ring bus network. In some embodiments, the transformer 202 assemblies may include circuit breakers for the plurality of electrolyzer power supplies supplied at the output or low-voltage end of the transformers 202. In some embodiments, a plurality of these daisy-chain or ring bus circuits may be provided for a large installation such that a total of 25 MW to 50 MW of power would be provided, such as 5 to 10 “stamps” or smaller instances of a plurality of electrolyzer power supplies and electrolyzer stacks.

A transformer load break switch 204 may be a load break switch designed to switch the power on or off or change the position when the transformer 202 is energized or has a load on it, and the switch will break it. The transformer load break switch 204 may be a switch that is a disconnect switch that is designed to provide making or breaking specified currents. The transformer load break switch 204 allows the transformer to receive the current from the substation 200 and then determine which power converters in the central power converter 206 will receive the current from the selected transformer 202. In some embodiments, the transformer load break switch 204 may allow the on and off electrical current transmission to a plurality of transformers 202 that transfer the electrical current to a plurality of power converters 206, which then provide power to a plurality of electrochemical stacks 104. The central power converter 206 may be an power converter that changes alternating current to direct current (rectifier) or direct current to alternating current (inverter) and/or provides various types of power conditioning. The resulting current is provided to the electrochemical stack 104.

In some embodiments, the substation 200 may provide a direct current to the transformer 202, and through the process described in the transformer load break switch 204, the power converter 206 may receive the direct current from the transformer 202, which is changed to an alternating current to supply power to the electrochemical stack 104. In some embodiments, a central power converter 206 may have all module strings centrally merged and large grid feeders often used in open-loop systems. The central power converter 206 may be a type of string power converter used in large-scale operations. The electrochemical stack 104 may contain a plurality of electrochemical stacks 104, which may be connected to various power converter modules from the central power converter 206. The electrochemical stacks 104 may receive power from the central power converters 206 in order to receive the necessary power to activate the electrochemical stack 104 and produce the hydrogen requested by the customer.

The substation 200, transformer 202, and power converter 206 for powering a given electrochemical stack 104 are collectively referred herein to as the stack's power distribution 210, which may be selectable in some embodiments. The power distribution 210 may be selected to provide redundancy and failure protection. For example, if a customer uses electrochemical stacks 1-3, each of the electrochemical stacks 1-3 may have a different power distribution 210, e.g., one or more different power converters 206, transformers 202, and/or substations 200. As a result, if a particular substation 200, transformer 202, and/or power converter 206 suffers a malfunction or is otherwise taken offline, at least a subset of the customer's electrochemical stacks 104 may continue to produce hydrogen without interruption. In other embodiments, the power distribution 210 is selected to reduce costs and/or to balance loads by wholly or partially sharing the same power distribution 210 for a plurality of electrochemical stacks 104.

The electrochemical stack 104 may include a first membrane electrode assembly (MEA), a second membrane electrode assembly (MEA), and a bipolar plate that collectively defines two complete electrochemical cells for hydrogen generation. The electrochemical stack 104 may also include a first end plate and a second end plate that may sandwich the first MEA, the second MEA, and the bipolar plate into contact with one another and direct the flow of fluids into and out of the electrochemical stack 104. While the electrochemical stack 104 is described as including two complete cells—a single bipolar plate and two MEAs—it shall be appreciated that this is for the sake of clarity of explanation only. It shall be more generally understood that the electrochemical stack 104 may include any number of MEAs and bipolar plates useful for meeting the hydrogen generation demands of the system 102 while maintaining separation between pressurized hydrogen and lower pressure water and oxygen flowing through the electrochemical stack 104. That is unless otherwise specified or made clear from the context. The electrochemical stack 104 may include more than one bipolar plate, a single MEA, and/or more than two MEAs. In some embodiments, an instance of the bipolar plate may be disposed between the first end plate and the first MEA and/or between the second end plate and the second MEA without departing from the scope of the present disclosure.

In general, the first MEA and the second MEA may be identical to one another. For example, the first MEA may include an anode, a cathode, and a proton exchange membrane (e.g., a PEM electrolyte) a therebetween. Similarly, the second MEA may include an anode, a cathode, and a proton exchange membrane therebetween. The anodes may each comprise an anode catalyst (i.e., electrode) contacting the membrane and an optional anode fluid diffusion layer. The cathodes may each comprise a cathode catalyst (i.e., electrode) contacting the membrane and an optional cathode gas diffusion layer. The anode electrode may comprise any suitable anode catalyst, such as an iridium layer. The anode fluid diffusion layer may comprise a porous material, mesh, or weave, such as a porous titanium sheet or a porous carbon sheet. The cathode electrode may comprise any suitable cathode catalyst, such as a platinum layer. The cathode gas diffusion layer may comprise porous carbon. Other noble metal catalyst layers may also be used for the anode and/or cathode electrodes. The electrolyte may comprise any suitable proton exchange (e.g., hydrogen ion transport) polymer membrane, such as a Nafion® membrane composed of sulfonated tetrafluoroethylene-based fluoropolymer-copolymer with a formula C₇HF₁₃O₅S·C₂F₄.

The bipolar plate may be disposed between the cathode of the first MEA and the anode of the second MEA. In general, the bipolar plate may include a substrate, an anode gasket, and a cathode gasket. The substrate has an anode (i.e., water) side and a cathode (i.e., hydrogen) side opposite one another. The anode gasket may be fixed to the anode side of the substrate, and the cathode gasket may be fixed to the cathode side of the substrate. Such fixed positioning of the anode gasket and the cathode gasket on opposite sides of the substrate may facilitate forming two seals that are consistently placed relative to one another and relative to the first MEA and the second MEA on either side of the bipolar plate. The gaskets form a double seal around the active areas, i.e., anode (e.g., water) flow field and cathode (e.g., hydrogen) flow field, located on respective opposite sides of the bipolar plate. Further, or instead, in instances in which an electrochemical stack 104 includes an instance of an MEA between two instances of the bipolar plate, the anode gasket and the cathode gasket may form a double seal along an active area of the MEA. Thus, more generally, the anode gasket and the cathode gasket may form a sealing engagement with one or more MEAs in an electrochemical stack to isolate flows within the electrode stack and, thus, reduce the likelihood that pressurized hydrogen may inadvertently mix with a flow of water and oxygen exiting the electrochemical stack to create a combustible hydrogen-oxygen mixture in the system 102.

The substrate may be formed of any one or more of various different types of materials that are electrically conductive, thermally conductive, and have strength suitable for withstanding the high pressure of hydrogen flowing along the cathode side of the substrate during use. Thus, for example, the substrate may be at least partially formed of one or more of plasticized graphite or carbon composite. Further, or instead, the substrate may be advantageously formed of one or more materials suitable for withstanding prolonged exposure to water on the anode side of the substrate. Accordingly, in some instances, the anode side of the substrate may include an oxidation inhibitor coating that is electrically conductive, examples of which include titanium, titanium oxide, titanium nitride, or a combination thereof. The oxidation inhibitor may generally extend at least along those portions of the anode side of the substrate exposed to water during the operation of the electrochemical stack 104. That is, the oxidation inhibitor may extend at least along the anode flow field inside the anode gasket on the anode side of the substrate. In some implementations, the oxide inhibitor may extend along the plurality of anode ports (i.e., water riser openings) which extend from the anode side to the cathode side of the substrate. The oxidation inhibitor may also be located in the anode plenums, which connect the anode portions to the anode flow field on the anode side of the substrate.

A cathode ring seal may be located around each cathode port (i.e., hydrogen riser opening) on the anode side of the substrate. The cathode ring seal prevents hydrogen from leaking out into the anode flow field on the anode side of the substrate. In contrast, an anode ring seal may be located around each one or more anode ports on the cathode side of the substrate. For example, two anode ports are surrounded by a common anode ring seal to prevent water from flowing into the cathode flow field on the cathode side of the substrate.

The anode flow field includes a plurality of straight and/or curved ribs separated by flow channels oriented to direct a liquid (e.g., purified water) between at least some of the plurality of anode ports, such as may be useful for evenly distributing purified water along the anode of the second MEA. The anode gasket may circumscribe the anode flow field and the plurality of anode ports along the anode side of the substrate to limit the movement of purified water moving along the anode. That is, the anode side of the substrate may be in sealed engagement with the anode of the second MEA via the anode gasket, such that anode channels are located therebetween. Under pressure provided by a source external to the electrochemical stack 104 (e.g., such as the pump of the water circuit), a liquid provided from the first fluid connector flows along the anode channels is directed across the anode of the second MEA, from one instance of the plurality of anode ports to another instance of the plurality of anode ports, where the liquid (e.g., remaining water and oxygen) may be directed out of the electrochemical stack 104 through another first fluid connector.

Additionally, the substrate may include a plurality of cathode ports (i.e., hydrogen riser openings), each extending from the anode side to the cathode side of the substrate. The cathode side of the substrate may include a cathode flow field. The cathode flow field includes a plurality of straight and/or curved ribs separated by cathode flow channels oriented to direct gas (e.g., hydrogen) toward the plurality of cathode ports, such as may be useful for directing pressurized hydrogen formed along the cathode of the first MEA. Cathode plenums may be located between the respective cathode ports and the cathode flow field. The cathode gasket may circumscribe the cathode flow field, the cathode plenums, and the plurality of cathode ports along the cathode side of the substrate to limit the movement of the pressurized hydrogen along the cathode. For example, the cathode side of the substrate may be in sealed engagement with the cathode of the first MEA via the cathode gasket, such that the cathode flow channels are defined between the cathode of the first MEA and the cathode side of the substrate. The pressure of the hydrogen formed along the cathode may move the hydrogen along at least a portion of the cathode channels and toward the cathode ports located diagonally opposite the cathode inlet port. The pressurized hydrogen may flow out of the cathode ports and out of the electrochemical stack 104 through the second fluid connector to be processed by the hydrogen circuit.

The anode gasket on the anode side of the substrate and the cathode gasket on the cathode side of the substrate may have different shapes. For example, the anode gasket may extend between the plurality of anode ports and the plurality of cathode ports on the anode side of the substrate. In other words, the anode gasket surrounds the anode ports and the anode flow field on one lateral side but leaves the cathode portions outside its circumscribed area. Therefore, the anode gasket may fluidically isolate anode flow from cathode flow in an installed position.

In contrast, the cathode gasket on the cathode side of the substrate does not extend between the plurality of anode ports and the plurality of cathode ports. In other words, the cathode gasket surrounds the anode ports, the cathode portions, and the cathode flow field. Instead, the anode ring seals isolate the anode portions from the cathode ports and the cathode flow field on the cathode side of the substrate.

In one configuration, the anode flow field and the cathode flow field may have the same shape, albeit on the opposite side of the substrate, to provide the same active area along the first MEA and the second MEA. Thus, taken together, the differences in shape between the anode gasket and the cathode gasket, along with the positioning of the anode ring seals and the same shape of the anode flow field and the cathode flow field, may result in different sealed areas. These different sealed areas are complementary to one another to facilitate fluidically isolating the lower pressure flow of purified water along the anode channels from the pressurized hydrogen flowing along the cathode channels while nevertheless allowing each flow to move through the electrochemical stack 104 and ultimately exit the electrochemical stack 104 along different channels.

In certain implementations, the cathode flow field may be shaped such that a minimum bounding rectangle of the cathode flow field is square. As used in this context, the term minimum bounding rectangle shall be understood to be a minimum rectangle defined by the maximum x- and y-dimensions of the cathode flow field. The plurality of cathode ports may include two cathode ports per substrate which are located at diagonally opposite corners from one another with respect to the minimum bounding rectangle (e.g., within the minimum bounding rectangle). The other two diagonally opposite corners lack the cathode ports. In instances in which the minimum bounding rectangle is square, the diagonal positioning of the cathode ports relative to the minimum bounding rectangle may facilitate the flow of pressurized hydrogen diagonally along the entire cathode flow field while leaving a large margin of the substrate material for strengths against the contained internal hydrogen pressure. Alternatively, the substrate may be a rectangle. The plurality of cathode ports are positioned away from the edges of the substrate such that each one of the plurality of cathode ports is well-reinforced by the material of the substrate between the respective one of the plurality of cathode ports and the closest edge of the substrate.

Given the large pressure differential between the flow of pressurized hydrogen along the cathode channels and the flow of water and oxygen along the anode channels, the electrochemical stack 104 may include the anode fluid diffusion layer disposed in the anode channels and optionally between the anode electrode of the anode of the second MEA and the anode side (e.g., anode ribs) of the substrate. The porous material of the anode fluid diffusion layer may generally permit the flow of water and oxygen through the anode channels without a substantial increase in flow restriction through the anode channels while providing structural support on the anode side of the substrate to resist collapse that may result from the pressure difference on opposite sides of the substrate. For the sake of clear illustration, the porous material is shown along only one anode channel. It shall be understood, however, the that porous material may be disposed inside all of the anode channels in certain implementations.

As an additional, or alternative, safety measure, the electrochemical stack 104 may include a housing disposed about the first MEA, the second MEA, the bipolar plate, the first end plate, and the second end plate. More specifically, the housing may be formed of one or more materials useful for absorbing the force of one or more materials that may become ejected in the event of a failure event (e.g., failure under the force of pressurized hydrogen and/or failure resulting from an explosion of an inadvertent hydrogen-containing mixture). For example, the housing may include one or more metal or aramid (e.g., Kevlar®) fibers.

Having described various features of the electrochemical stack 104, attention is now directed to a description of the operation of the electrochemical stack 104 to form pressurized hydrogen with water and electricity as inputs. In particular, an electric field E (i.e., voltage) may be applied across the electrochemical stack 104 (i.e., between the end plates) from the power source 106. The bipolar plate may electrically connect the first MEA and the second MEA in series with one another such that electrolysis may take place at the first MEA and the second MEA to form a flow of pressurized hydrogen that is maintained fluidically isolated from lower pressure water and oxygen, except for proton exchange occurring through the proton exchange membrane and the proton exchange membrane.

Purified water (e.g., from the water circuit) may be introduced into the electrochemical stack 104 via the first fluid connector of the system 102. Within the electrochemical stack 104, the purified water may flow along an intake channel that extends through the bipolar plate, among other components, to direct the purified water to the anode of the first MEA and to the anode of the second MEA. With the electric field E applied across the anode and the cathode of the first MEA, the purified water may break down along the anode into protons (H⁺) and oxygen. The protons (H⁺) may move from the anode to the cathode through the proton exchange membrane. At the cathode, the protons (H⁺) may combine with one another to form pressurized hydrogen along the cathode. Through an analogous process, pressurized hydrogen may also be formed along the cathode of the second MEA. The flows of pressurized hydrogen formed by each of the first MEA and the second MEA may combine with one another and flow out of the electrochemical stack 104 via two hydrogen exhaust channels that extend through the bipolar plate, among other components, to ultimately direct the pressurized hydrogen out of the second fluid connector of the system 102 and toward the hydrogen circuit for processing. The flows of oxygen and water along the first anode and the second anode may combine with one another and flow out of the electrochemical stack 104 via the outlet anode ports and an outlet channel that extends through the end plate, among other components, to direct this stream of water and oxygen out of the first fluid connector of the system 102 and toward the water circuit for processing.

As discussed above, the bipolar plate may be in sealed engagement with the cathode of the first MEA and the anode of the second MEA to facilitate keeping pressurized hydrogen formed along the cathode of the first MEA separate from water and oxygen flowing along the anode of the second MEA. This separation is useful for reducing the likelihood of leakage of pressurized hydrogen from the electrochemical stack 104 and, thus, may be useful in addition to, or instead of, any one or more aspects of the modularity of the system 102 with respect to safely producing industrial-scale quantities of hydrogen through electrolysis. Additionally, or alternatively, the sealed engagement facilitated by the bipolar plate may facilitate dismantling the system 102 (e.g., to repair, maintain, and/or replace the electrochemical stack 104) with a lower likelihood of spilling water in the vicinity of the cabinet.

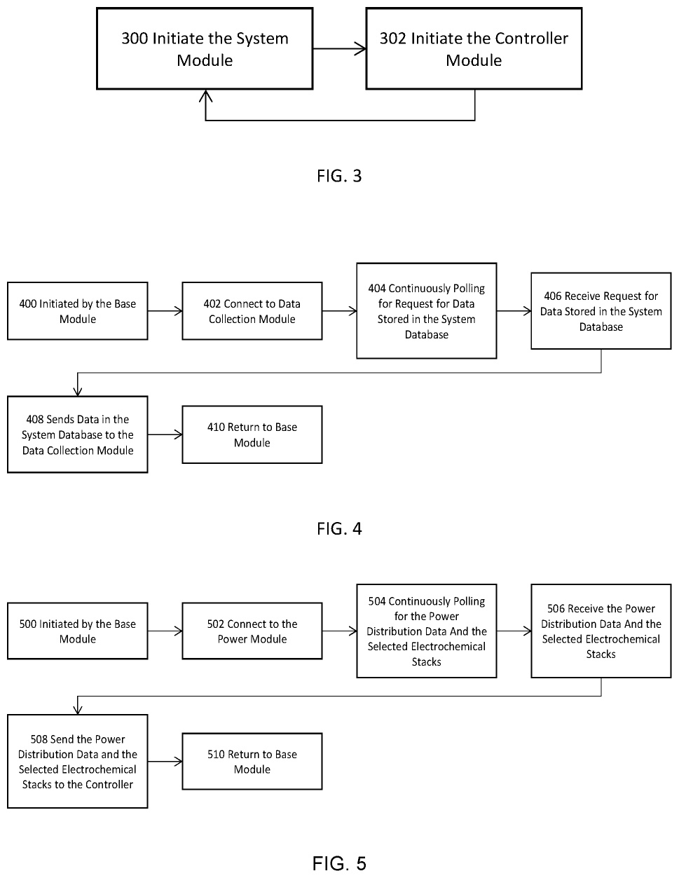

FIG. 3 is a flowchart of a process performed by a base module 122. The process begins with the base module 122 initiating, at step 300, the system module 124. For example, the system module 124 may begin by being initiated by the base module 122. Then, the system module 124 connects to the data collection module 136. The system module 124 is continuously polling for a request for the data stored in the system database 128 from the data collection module 136. The system module 124 receives the request from the data collection module 136 for the data stored in the system database 128. The system module 124 sends the data stored in the system database 128 to the data collection module 136, after which the system module 124 returns to the base module 122.

At step 302, the base module 122 initiates the controller module 126. For example, the controller module 126 may begin by being initiated by the base module 122. Then, the controller module 126 connects to the power module 138. The controller module 126 continuously polls for the power distribution data and the selected electrochemical stacks 104 from the power module 138. Then, the controller module 126 receives the power distribution data and the selected electrochemical stacks 104 from the power module 138. The controller module 126 sends the power distribution data and the selected electrochemical stacks 104 to the controller 112, after which the controller module 126 returns to the base module 122.

FIG. 4 is a flowchart of a process performed by the system module 124. The process begins with the system module 124 being initiated, at step 400, by the base module 122. Then the system module 124 connects, at step 402, to the data collection module 136. Then, the system module 124 is continuously polling, at step 404, for a request for the data stored in the system database 128 from the data collection module 136. For example, the system module 124 is continuously polling to receive a request for data, such as the power distribution data for each of the electrochemical stacks 104 within the system 102. The database contains the client's name, the electrochemical stack 104 number, the power converter number for the electrochemical stack 104, the transformer number for the power converter, the average rate of hydrogen production for the electrochemical stack 104, the water required for the electrochemical stack 104, and the status of the electrochemical stack 104. In some embodiments, the electrochemical stack 104, the power converter, and the transformer may have a specific identification, including a series of numbers, letters, characters, etc., to uniquely identify each component. In some embodiments, the transformers may send power to a plurality of power converters, and the power converters may power a plurality of electrochemical stacks 104.

At step 406, the system module 124 receives the request from the data collection module 136 for the data stored in the system database 128. For example, the system module 124 receives a request for data, such as the power distribution data for each of the electrochemical stacks 104 within the system 102. The database contains the client's name, the electrochemical stack 104 number, the power converter number for the electrochemical stack 104, the transformer number for the power converter, the average rate of hydrogen production for the electrochemical stack 104, the water required for the electrochemical stack 104, and the status of the electrochemical stack 104. In some embodiments, the electrochemical stack 104, the power converter, and the transformer may have a specific identification, including a series of numbers, letters, characters, etc., to uniquely identify each component. In some embodiments, the transformers may send power to a plurality of power converters, and the power converters may power a plurality of electrochemical stacks 104.

At step 408, the system module 124 sends the data stored in the system database 128 to the data collection module 136. For example, the system module 124 sends data to the data collection module 136, such as the power distribution data for each electrochemical stack 104 within the system 102. The database contains the client's name, the electrochemical stack 104 number, the power converter number for the electrochemical stack 104, the transformer number for the power converter, the average rate of hydrogen production for the electrochemical stack 104, the water required for the electrochemical stack 104, and the status of the electrochemical stack 104. In some embodiments, the electrochemical stack 104, the power converter, and the transformer may have a specific identification, including a series of numbers, letters, characters, etc., to uniquely identify each of the components. In some embodiments, the transformers may send power to a plurality of power converters, and the power converters may power a plurality of electrochemical stacks 104. The system module 124 returns, at step 410, to the base module 122.

FIG. 5 is a flowchart of a process performed by the controller module 126. The process begins with the controller module 126 being initiated, at step 500, by the base module 122. Then the controller module 126 connects, at step 502, to the power module 138. The controller module 126 is continuously polling, at step 504, for the power distribution data and the selected electrochemical stacks 104 from the power module 138. For example, the controller module 126 is continuously polling to receive the data, such as the electrochemical stack 104 number, the power converter number for the electrochemical stack 104, the transformer number for the power converter, and the amount of water required for each electrochemical stack 104, etc. Then the controller module 126 receives, at step 506, the power distribution data and the selected electrochemical stacks 104 from the power module 138. For example, the controller module 126 receives the power distribution data from the power module 138, such as the electrochemical stack 104 number, the power converter number for the electrochemical stack 104, the transformer number for the power converter, the amount of water required for each electrochemical stack 104, etc.

At step 508, the controller module 126 sends the power distribution data and the selected electrochemical stacks 104 to the controller 112. For example, the controller module 126 sends the power distribution data, such as the electrochemical stack 104 number, the power converter number for the electrochemical stack 104, the transformer number for the power converter, and the amount of water required for each electrochemical stack 104, etc. to the controller 112. For example, the power distribution data provides the controller 112 with the information necessary to power the system 102 by activating the correct transformers, then activating the correct power converters, and activating the correct electrochemical stacks 104 so that the selected electrochemical stacks 104 have the power necessary to meet the hydrogen request from the customer. The controller module 126 returns, at step 510, to the base module 122.

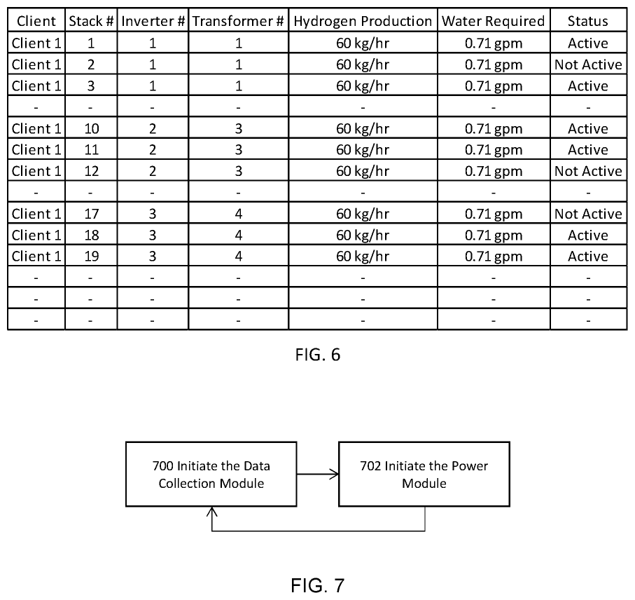

FIG. 6 illustrates the system database 128. The database contains the power distribution data for each electrochemical stack 104 within the system 102. The database contains the client's name, the electrochemical stack 104 number, the power converter number for the electrochemical stack 104, the transformer number for the power converter, the average rate of hydrogen production for the electrochemical stack 104, the water required for the electrochemical stack 104, and the status of the electrochemical stack 104. In some embodiments, the electrochemical stack 104, the power converter, and the transformer may have a specific identification, including a series of numbers, letters, characters, etc., to uniquely identify each of the components. In some embodiments, the transformers may send power to a plurality of power converters, and the power converters may power a plurality of electrochemical stacks 104.

FIG. 7 is a flowchart of a process performed by the E.N. base module 134. The process begins with the E.N. base module 134 initiating, at step 700, the data collection module 136. For example, the data collection module 136 begins by being initiated by the E.N. base module 134. The data collection module 136 connects to the base module 122. Then the data collection module 136 sends a request to the base module 122 for the data stored in the system database 128. The data collection module 136 is continuously polling to receive the data stored in the system database 128 from the base module 122. The data collection module 136 receives the data stored in the system database 128 from the base module 122. The data collection module 136 then stores the received data in the stack database 140. The data collection module 136 connects to the customer module 150. Then the data collection module 136 sends a request to the customer module 150 for the data stored in the hydrogen database 152. The data collection module 136 is continuously polling to receive the data stored in the hydrogen database 152 from the customer module 150. The data collection module 136 receives the data stored in the hydrogen database 152 from the customer module 150. Then the data collection module 136 stores the received data in the customer database 142. The data collection module 136 returns to the E.N. base module 134.

At step 702, the E.N. base module 134 initiates the power module 138. For example, the power module 138 begins by being initiated by the E.N. base module 134. The power module 138 extracts the hydrogen request from the customer database 142. The power module 138 then determines the number of electrochemical stacks 104 needed to meet the customer's hydrogen request. The power module 138 filters the stack database 140 on the client's name. Then, the power module 138 filters the stack database 140 on the active electrochemical stacks 104. The power module 138 selects the electrochemical stacks 104 needed to meet the customer's hydrogen request. Then the power module 138 extracts the power distribution data for the selected electrochemical stacks 104. The power module 138 connects to the controller module 126. The power module 138 sends the extracted power distribution data and the selected electrochemical stacks 104 to the controller module 126. The power module 138 then returns to the E.N. base module 134.

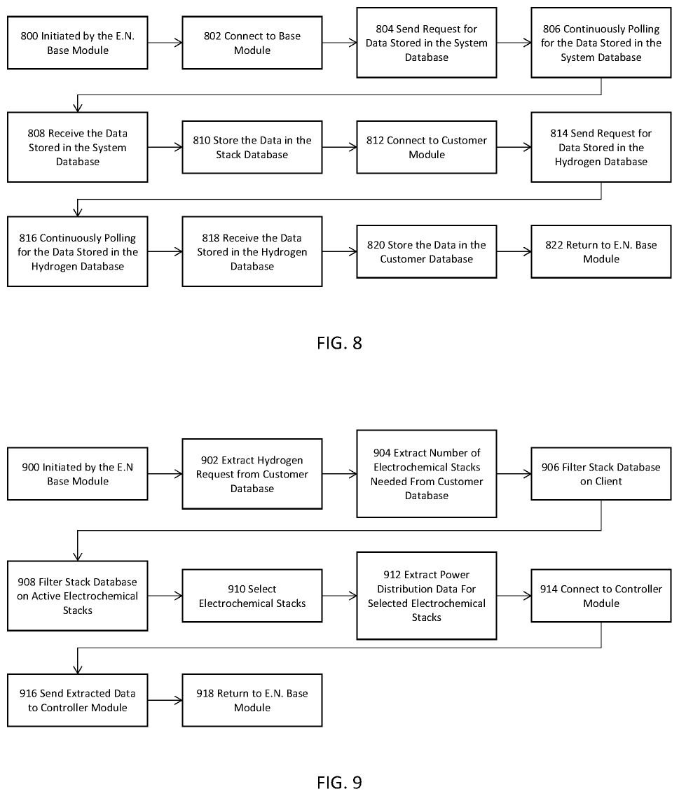

FIG. 8 is a flowchart of a process performed by the data collection module 136. The process begins with the data collection module 136 being initiated, at step 800, by the E.N. base module 134. The data collection module 136 connects, at step 802, to the base module 122. The data collection module 136 then sends, at step 804, a request to the base module 122 for the data stored in the system database 128. For example, the data collection module 136 sends a request to the base module for data stored in the system database 128, such as the power distribution data for each electrochemical stack 104 within the system 102. The database contains the client's name, the electrochemical stack 104 number, the power converter number for the electrochemical stack 104, the transformer number for the power converter, the average rate of hydrogen production for the electrochemical stack 104, the water required for the electrochemical stack 104, and the status of the electrochemical stack 104. In some embodiments, the electrochemical stack 104, the power converter, and the transformer may have a specific identification, including a series of numbers, letters, characters, etc., to uniquely identify each of the components. In some embodiments, the transformers may send power to a plurality of power converters, and the power converters may power a plurality of electrochemical stacks 104.

At step 806, the data collection module 136 is continuously polling to receive the data stored in the system database 128 from the base module 122. For example, the data collection module 136 is continuously polling to receive the data, such as the power distribution data for each electrochemical stack 104 within the system 102. The database contains the client's name, the electrochemical stack 104 number, the power converter number for the electrochemical stack 104, the transformer number for the power converter, the average rate of hydrogen production for the electrochemical stack 104, the water required for the electrochemical stack 104, and the status of the electrochemical stack 104. In some embodiments, the electrochemical stack 104, the power converter, and the transformer may have a specific identification, including a series of numbers, letters, characters, etc., to uniquely identify each of the components. In some embodiments, the transformers may send power to a plurality of power converters, and the power converters may power a plurality of electrochemical stacks 104.

At step 808, the data collection module 136 receives the data stored in the system database 128 from the base module 122. The data collection module 136 receives the data, such as the power distribution data for each of the electrochemical stacks 104 within the system 102. The database contains the client's name, the electrochemical stack 104 number, the power converter number for the electrochemical stack 104, the transformer number for the power converter, the average rate of hydrogen production for the electrochemical stack 104, the water required for the electrochemical stack 104, and the status of the electrochemical stack 104. In some embodiments, the electrochemical stack 104, the power converter, and the transformer may have a specific identification, including a series of numbers, letters, characters, etc., to uniquely identify each of the components. In some embodiments, the transformers may send power to a plurality of power converters, and the power converters may power a plurality of electrochemical stacks 104.

At step 810, the data collection module 136 stores the received data in the stack database 140. For example, the data collection module 136 stores the data in the stack database 140, which contains the power distribution data for each electrochemical stack 104 within each client's system 102. The database contains the client's name, the electrochemical stack 104 number, the power converter number for the electrochemical stack 104, the transformer number for the power converter, the average rate of hydrogen production for the electrochemical stack 104, the water required for the electrochemical stack 104, and the status of the electrochemical stack 104. In some embodiments, the electrochemical stack 104, the power converter, and the transformer may have a specific identification, including a series of numbers, letters, characters, etc., to uniquely identify each of the components. In some embodiments, the transformers may send power to a plurality of power converters, and the power converters may power a plurality of electrochemical stacks 104.

At step 812, the data collection module 136 connects to the customer module 150. The data collection module 136 then sends, at step 814, a request to the customer module 150 for the data stored in the hydrogen database 152. For example, the data collection module 136 sends a request to the customer module 150 for data, such as the customer's name, such as client 1, the total number of electrochemical stacks 104 the client has within their system 102, the hydrogen request, such as 600 kg of hydrogen, the number of electrochemical stacks needed to complete the hydrogen request, the date, and the time. In some embodiments, the database may contain a customer ID, the customer's location, the number of active electrochemical stacks, and the number of electrochemical stacks that are not active. In some embodiments, the hydrogen request may be daily, hourly, weekly, monthly, quarterly, yearly, etc. In some embodiments, the user may not have to input the hydrogen request, such as having an automated system that may determine the hydrogen request by reading a database of the customer's orders, required shipments, etc.

At step 816, the data collection module 136 is continuously polling to receive the data stored in the hydrogen database 152 from the customer module 150. For example, the data collection module 136 is continuously polling for the data, such as the customer's name, such as client 1, the total number of electrochemical stacks 104 the client has within their system 102, the hydrogen request, such as 600 kg of hydrogen, the number of electrochemical stacks needed to complete the hydrogen request, the date, and the time. In some embodiments, the database may contain a customer ID, the customer's location, the number of active electrochemical stacks, and the number of electrochemical stacks that are not active. In some embodiments, the hydrogen request may be daily, hourly, weekly, monthly, quarterly, yearly, etc. In some embodiments, the user may not have to input the hydrogen request, such as having an automated system that may determine the hydrogen request by reading a database of the customer's orders, required shipments, etc.

At step 818, the data collection module 136 receives the data stored in the hydrogen database 152 from the customer module 150. For example, the data collection module receives the data from the customer module 150, such as the customer's name, such as client 1, the total number of electrochemical stacks 104 the client has within their system 102, the hydrogen request, such as 600 kg of hydrogen, the number of electrochemical stacks needed to complete the hydrogen request, the date, and the time. In some embodiments, the database may contain a customer ID, the customer's location, the number of active electrochemical stacks, and the number of electrochemical stacks that are not active. In some embodiments, the hydrogen request may be daily, hourly, weekly, monthly, quarterly, yearly, etc. In some embodiments, the user may not have to input the hydrogen request, such as having an automated system that may determine the hydrogen request by reading a database of the customer's orders, required shipments, etc.

At step 820, the data collection module 136 stores the received data in the customer database 142. For example, the data collection module 136 stores the data in the customer database 142, which contains the customer's name, such as client 1, the total number of electrochemical stacks 104 the client has within their system 102, the number of electrochemical stacks needed to complete the hydrogen request, the hydrogen request, such as 600 kg of hydrogen, the amount of hydrogen generated, the date and the time. In some embodiments, the database may contain a customer ID, the customer's location, the number of active electrochemical stacks, and the number of electrochemical stacks that are not active. In some embodiments, the hydrogen request may be daily, hourly, weekly, monthly, quarterly, yearly, etc. In some embodiments, the user may not have to input the hydrogen request, such as having an automated system that may determine the hydrogen request by reading a database of the customer's orders, required shipments, etc. In some embodiments, the database may contain the amount of hydrogen stored in the storage tanks 120 if additional hydrogen was produced. For example, if a renewable energy source was used for hydrogen production at a lower cost, the system 102 may generate additional hydrogen since it is cheaper to produce using an energy source that has a lower cost than the grid energy source. The data collection module 136 returns, at step 822, to the E.N. base module 134.

FIG. 9 is a flowchart of a process performed by the power module 138. The process begins with the power module 138 being initiated, at step 900, by the E.N. base module 134. The power module 138 extracts, at step 902, the hydrogen request from the customer database 142. For example, the power module 138 extracts the customer's hydrogen request of 600 kg of hydrogen from the customer database 142. In some embodiments, the hydrogen request may be a daily request, an hourly request, a weekly request, etc. Then the power module 138 extracts, at step 904, the number of electrochemical stacks 104 needed to meet the customer's hydrogen request from the customer database 142. For example, the power module 138 extracts the number of electrochemical stacks 104 needed to produce the 600 kg of hydrogen from the customer database 142, such as 10 electrochemical stacks 104 are needed. In some embodiments, the power module 138 may determine the number of electrochemical stacks needed to produce the hydrogen request by using a database that includes which electrochemical stacks 104 are currently available, which power converters are currently available, which transformers are currently available, etc., allowing the power module 138 to select electrochemical stacks 104 that can become active and not select ones that are currently going under maintenance.

At step 906, the power module 138 filters the stack database 140 on the client's name. For example, the power module 138 filters the stack database 140 on “client 1” to filter the database on only the electrochemical stacks 104 for the customer with the current hydrogen request. Then the power module 138 filters, at step 908, the stack database 140 on the active electrochemical stacks 104. For example, the power module 138 filters the stack database 140 on the active electrochemical stacks 104, which may include electrochemical stacks 104 that are ready to be operated and do not require maintenance, or have an power converter that requires maintenance, or have a transformer that requires maintenance.

At step 910, the power module 138 selects the electrochemical stacks 104 needed to meet the customer's hydrogen request. In some embodiments, the power module 138 may select the electrochemical stacks 104 based on status data obtained, for example, from the system database 128 of FIG. 6. The status data may include, for example, an indication of which electrochemical stacks 104 are active and a rate of hydrogen production for each active electrochemical stack 104. Based on the status data, the power module 138 will allocate a sufficient number of active electrochemical stacks 104 to be able to satisfy the customer's hydrogen request. In an embodiment in which a particular customer has an allocated set of electrochemical stacks 104, the power module 138 may filter the system database 128 to only select electrochemical stacks allocated to the particular customer.

In some embodiments, the power module 138 may select the electrochemical stacks 104 based on having the same or similar power distribution 210 (e.g., power converter 206, transformer 202, and/or substation 200). In some embodiments, the power module 138 may select electrochemical stacks 104 that have a different or partially different power distribution in the case of a malfunction. In some embodiments, the power module 138 may select some electrochemical stacks 104 that have the same power distribution 210, as well as electrochemical stacks 104 that may have a different power distributions 210. In still other embodiments, the power module 138 may select the electrochemical stacks 104 to balance the load on various substations 200, transformers 202, power converters 206, and the like.

At step 912, the power module 138 extracts the power distribution data for the selected electrochemical stacks 104. For example, the power module 138 extracts the power distribution data for the selected electrochemical stacks 104, such as the electrochemical stack 104 number, the power converter number for the electrochemical stack 104, the transformer number for the power converter, the amount of water required for each electrochemical stack 104, etc. The power module 138 connects, at step 914, to the controller module 126. The power module 138 sends, at step 916, the extracted power distribution data and the selected electrochemical stacks 104 to the controller module 126. For example, the power module 138 sends the power distribution data to the controller module 126, such as the electrochemical stack 104 number, the power converter number for the electrochemical stack 104, the transformer number for the power converter, the amount of water required for each electrochemical stack 104, etc. The power module 138 returns, at step 918, to the E.N. base module 134.

In some embodiments, the power module 138 may select a power distribution 210 (e.g., substation 200, transformer 202, and/or power converter 206) for each selected electrochemical stack 104. This may include selecting the power distribution 210 for one selected electrochemical stack 104 that is the same as the power distribution 210 of another selected electrochemical stack 104, which may be helpful in load balancing, cost reduction, or power optimization. Alternatively, the power distribution 210 for one selected electrochemical stack 104 may be different from the power distribution 210 of another selected electrochemical stack 104, which may be useful for mitigating the effects of a malfunction. For example, if the electrochemical stacks 104 of a customer use different power distributions 210, then the failure of one power distribution 210 will not entirely halt hydrogen production for the customer.

In some embodiments, the selection of the power distribution 210 may rely on power distribution data including an indication of any power distributions 210 that will be out of service during the particular time interval, such as planned maintenance or the like. In such a case, the power module 138 may exclude power distributions 210 for selection that will be out of service during the particular time interval of the request, e.g., daily, hourly, weekly, monthly, quarterly, yearly. The power distribution data may be received from the system database 128 and/or other sources.

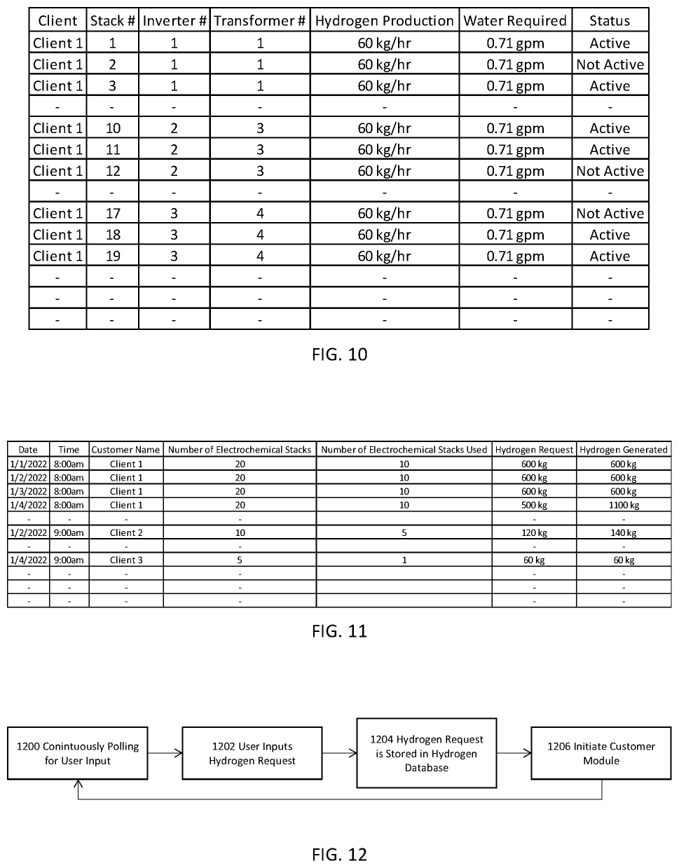

FIG. 10 illustrates the stack database 140. The database contains the power distribution data for each electrochemical stack 104 within each client's systems 102. The database contains the client's name, the electrochemical stack 104 number, the power converter number for the electrochemical stack 104, the transformer number for the power converter, the average rate of hydrogen production for the electrochemical stack 104, the water required for the electrochemical stack 104, and the status of the electrochemical stack 104. In some embodiments, the electrochemical stack 104, the power converter, and the transformer may have a specific identification, including a series of numbers, letters, characters, etc., to uniquely identify each of the components. In some embodiments, the transformers may send power to a plurality of power converters, and the power converters may power a plurality of electrochemical stacks 104.

FIG. 11 illustrates the customer database 142. The customer database 142 contains the customer's name, such as client 1, the total number of electrochemical stacks 104 the client has within their system 102, the number of electrochemical stacks needed to complete the hydrogen request, the hydrogen request, such as 600 kg of hydrogen, the amount of hydrogen generated, the date and the time. In some embodiments, the database may contain a customer ID, the customer's location, the number of active electrochemical stacks, and the number of electrochemical stacks that are not active. In some embodiments, the hydrogen request may be daily, hourly, weekly, monthly, quarterly, yearly, etc. In some embodiments, the user may not have to input the hydrogen request, such as having an automated system that may determine the hydrogen request by reading a database of the customer's orders, required shipments, etc. In some embodiments, the database may contain the amount of hydrogen stored in the storage tanks 120 if additional hydrogen was produced. For example, if a renewable energy source was used for hydrogen production at a lower cost, the system 102 may generate additional hydrogen since it is cheaper to produce using an energy source that has a lower cost than the grid energy source.

FIG. 12 is a flowchart of a process performed by the C.N. base module 148. The process begins with the C.N. base module 148 continuously polling, at step 1200, for the user input. For example, the user input may be the customer's hydrogen request for the day, such as 600 kg of hydrogen that the customer requires. In some embodiments, the user inputs may be inputted throughout the day, for the entire day, week, month, quarter, year, year, etc. In some embodiments, the user inputs may be sent to the system 102 in order to let the system 102 know how much hydrogen needs to be produced and informs the system 102 how long the electrochemical stacks 104 should be activated for. The user then inputs, at step 1202, the hydrogen request. For example, the user input may be the customer's hydrogen request for the day, such as 600 kg of hydrogen that the customer requires. In some embodiments, the user inputs may be inputted throughout the day, for the entire day, week, month, quarter, year, year, etc. In some embodiments, the user inputs may be sent to the system 102 in order to let the system 102 know how much hydrogen needs to be produced and informs the system 102 how long the electrochemical stacks 104 should be activated for.

At step 1204, the C.N. base module 148 stores the hydrogen request in the hydrogen database 152. For example, the hydrogen database 152 may contain the customer's name, such as client 1, the total number of electrochemical stacks 104 the client has within their system 102, the hydrogen request, such as 600 kg of hydrogen, the number of electrochemical stacks needed to complete the hydrogen request, the date, and the time. In some embodiments, the database may contain a customer ID, the customer's location, the number of active electrochemical stacks, and the number of electrochemical stacks that are not active. In some embodiments, the hydrogen request may be daily, hourly, weekly, monthly, quarterly, yearly, etc. In some embodiments, the user may not have to input the hydrogen request, such as having an automated system that may determine the hydrogen request by reading a database of the customer's orders, required shipments, etc.

At step 1206, the C.N. base module 148 initiates the customer module 150. For example, the customer module 150 begins by being initiated by the C.N. base module 148. Then the customer module 150 is continuously polling for a request from the data collection module 136 for the data stored in the hydrogen database 152. The customer module 150 receives a request for the data stored in the hydrogen database 152 from the data collection module 136. Then the customer module 150 sends the data stored in the hydrogen database 152 to the data collection module 136. The customer module 150 returns to the C.N. base module 148.

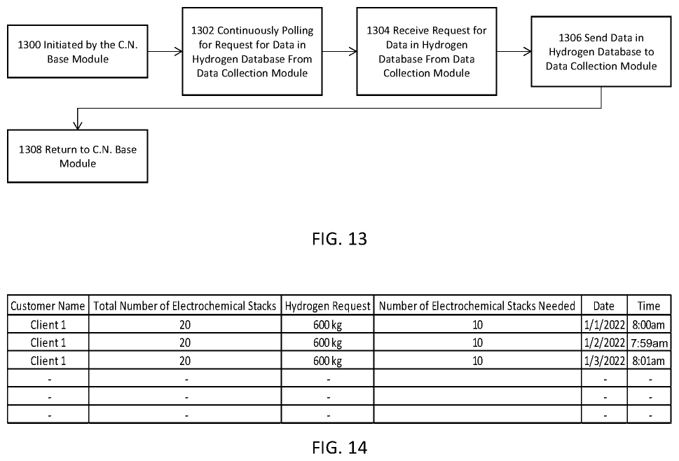

FIG. 13 is a flowchart of a process performed by the customer module 150. The process begins with the customer module 150 being initiated, at step 1300, by the C.N. base module 148. At step 1302, the customer module 150 is continuously polling for a request from the data collection module 136 for the data stored in the hydrogen database 152. For example, the customer module 150 is continuously polling to receive a request for data, such as the customer's name, such as client 1, the total number of electrochemical stacks 104 the client has within their system 102, the hydrogen request, such as 600 kg of hydrogen, the number of electrochemical stacks needed to complete the hydrogen request, the date, and the time. In some embodiments, the database may contain a customer ID, the customer's location, the number of active electrochemical stacks, and the number of electrochemical stacks that are not active. In some embodiments, the hydrogen request may be daily, hourly, weekly, monthly, quarterly, yearly, etc. In some embodiments, the user may not have to input the hydrogen request, such as having an automated system that may determine the hydrogen request by reading a database of the customer's orders, required shipments, etc.

At step 1304, the customer module 150 receives a request for the data stored in the hydrogen database 152 from the data collection module 136. For example, the customer module 150 receives a request for the data stored in the hydrogen database 152, such as the customer's name, such as client 1, the total number of electrochemical stacks 104 the client has within their system 102, the hydrogen request, such as 600 kg of hydrogen, the number of electrochemical stacks needed to complete the hydrogen request, the date, and the time. In some embodiments, the database may contain a customer ID, the customer's location, the number of active electrochemical stacks, and the number of electrochemical stacks that are not active. In some embodiments, the hydrogen request may be daily, hourly, weekly, monthly, quarterly, yearly, etc. In some embodiments, the user may not have to input the hydrogen request, such as having an automated system that may determine the hydrogen request by reading a database of the customer's orders, required shipments, etc.

At step 1306, the customer module 150 sends the data stored in the hydrogen database 152 to the data collection module 136. For example, the customer module 150 sends the data to the data collection module 136, such as the customer's name, such as client 1, the total number of electrochemical stacks 104 the client has within their system 102, the hydrogen request, such as 600 kg of hydrogen, the number of electrochemical stacks needed to complete the hydrogen request, the date, and the time. In some embodiments, the database may contain a customer ID, the customer's location, the number of active electrochemical stacks, and the number of electrochemical stacks that are not active. In some embodiments, the hydrogen request may be daily, hourly, weekly, monthly, quarterly, yearly, etc. In some embodiments, the user may not have to input the hydrogen request, such as having an automated system that may determine the hydrogen request by reading a database of the customer's orders, required shipments, etc. The customer module 150 returns, at step 1308, to the C.N. base module 148.

FIG. 14 illustrates the hydrogen database 152. The hydrogen database 152 contains the customer's name, such as client 1, the total number of electrochemical stacks 104 the client has within their system 102, the hydrogen request, such as 600 kg of hydrogen, the number of electrochemical stacks needed to complete the hydrogen request, the date, and the time. In some embodiments, the database may contain a customer ID, the customer's location, the number of active electrochemical stacks, and the number of electrochemical stacks that are not active. In some embodiments, the hydrogen request may be daily, hourly, weekly, monthly, quarterly, yearly, etc. In some embodiments, the user may not have to input the hydrogen request, such as having an automated system that may determine the hydrogen request by reading a database of the customer's orders, required shipments, etc.

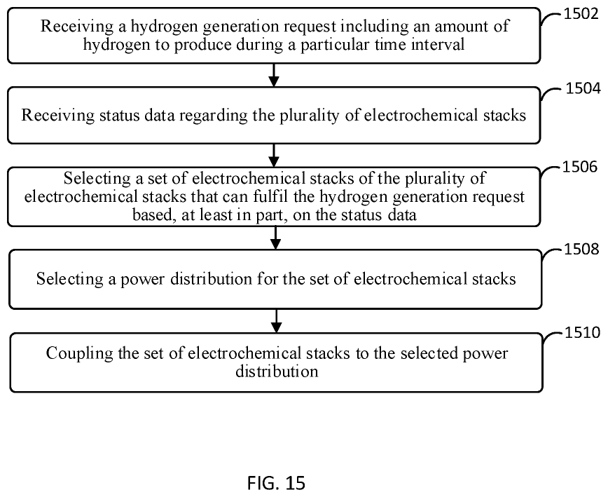

FIG. 15 is a flowchart of a method for distributing power to a hydrogen generation system having a plurality of electrochemical stacks. The method begins at step 1502 by receiving a hydrogen generation request including an amount of hydrogen to produce during a particular time interval. A process of receiving a hydrogen generation request from a customer is described in connection with FIG. 12. At step 1504, the method continues by receiving status data regarding the plurality of electrochemical stacks 104 (illustrated in FIG. 1). The status data may be obtained, for example, via the system database 128, and stored a memory.

At step 1506, the method continues by selecting a set of electrochemical stacks 104 of the plurality of electrochemical stacks that can fulfil the hydrogen generation request based, at least in part, on the status data. A process of selecting the set of electrochemical stacks 104 is described in connection with FIG. 9. The method continues at step 1508 by selecting a power distribution 210 (illustrated in FIG. 2) for the set of electrochemical stacks 104, one example of which is described with reference to FIG. 9. At step 1510, the method continues by coupling the set of electrochemical stacks 104 to the selected power distribution 210, as described with reference to FIG. 5. For example, this may include sending power distribution data to the controller 112, which may then control one or more switches, such as the transformer load break switches 204 of FIG. 2, to achieve a selected power distribution 210 for a given electrochemical stack 104.

Numerous examples are provided herein to enhance understanding of the present disclosure. A specific set of statements is provided as follows.

Statement 1. A method for distributing power to a hydrogen generation system, the hydrogen generation system including a plurality of electrochemical stacks, the method comprising: receiving a hydrogen generation request including an amount of hydrogen to produce during a particular time interval; receiving status data regarding the plurality of electrochemical stacks; selecting a set of electrochemical stacks of the plurality of electrochemical stacks that can fulfil the hydrogen generation request based, at least in part, on the status data; selecting a power distribution for the set of electrochemical stacks; and coupling the set of electrochemical stacks to the selected power distribution.

Statement 2. The method of statement 1, wherein receiving the status data includes receiving an indication of which electrochemical stacks of the plurality of electrochemical stacks are active and a rate of hydrogen production for at least one active electrochemical stack of the plurality of electrochemical stacks.

Statement 3. The method of statements 1-2, wherein selecting the set of electrochemical stacks comprises selecting the set of electrochemical stacks based which electrochemical stacks of the plurality of electrochemical stacks are active and the rate of hydrogen production for the at least one active electrochemical stack of the plurality of electrochemical stacks.

Statement 4. The method of statements 1-3, wherein the status data includes the power distribution for one or more of the plurality of electrochemical stacks, and wherein selecting the set of electrochemical stacks comprises selecting an electrochemical stack that has a same power distribution as another selected electrochemical stack.

Statement 5. The method of statements 1-4, wherein the status data includes the power distribution for one or more of the plurality of electrochemical stacks, and wherein selecting the set of electrochemical stacks comprises selecting an electrochemical stack that has a different power distribution as another selected electrochemical stack.

Statement 6. The method of statements 1-5, wherein selecting the power distribution for the set of electrochemical stacks comprises selecting one or more of a power converter, a transformer, and a substation.

Statement 7. The method of statements 1-6, wherein selecting the power distribution for the set of electrochemical stacks comprises selecting the power distribution for one selected electrochemical stack that is the same as the power distribution of another selected electrochemical stack.

Statement 8. The method of statements 1-7, wherein selecting the power distribution for the set of electrochemical stacks comprises selecting the power distribution for one selected electrochemical stack that is different from the power distribution of another selected electrochemical stack.

Statement 9. The method of statements 1-8, wherein selecting the power distribution for the set of electrochemical stacks comprises balancing a power distribution load among a plurality of power distributions.

Statement 10. The method of statements 1-8, further comprising receiving power distribution data including an indication of any power distributions that will be out of service during the particular time interval, wherein selecting the power distribution for the set of electrochemical stacks comprises excluding power distributions for selection that will be out of service during the particular time interval.

Statement 11. A system for distributing power to a hydrogen generation system, the hydrogen generation system including a plurality of electrochemical stacks, the system comprising: a communication interface to receive a hydrogen generation request including an amount of hydrogen to produce during a particular time interval; a memory to store status data regarding the plurality of electrochemical stacks; one or more processors to select a set of electrochemical stacks of the plurality of electrochemical stacks that can fulfil the hydrogen generation request based, at least in part, on the status data, wherein the processor is further to select a power distribution for the set of electrochemical stacks and initiate coupling of the set of electrochemical stacks to the selected power distribution.

Statement 12. The system of statement 11, the status data includes an indication of which electrochemical stacks of the plurality of electrochemical stacks are active and a rate of hydrogen production for at least one active electrochemical stack of the plurality of electrochemical stacks.

Statement 13. The system of statements 11-12, wherein the one or more processors are to select the set of electrochemical stacks based which electrochemical stacks of the plurality of electrochemical stacks are active and the rate of hydrogen production for the at least one active electrochemical stack of the plurality of electrochemical stacks.

Statement 14. The system of statements 11-13, wherein the status data includes the power distribution for one or more of the plurality of electrochemical stacks, and wherein the one or more processors are to select an electrochemical stack that has a same power distribution as another selected electrochemical stack.

Statement 15. The system of statements 11-14, wherein the status data includes the power distribution for one or more of the plurality of electrochemical stacks, and wherein the one or more processors are to select an electrochemical stack that has a different power distribution as another selected electrochemical stack.

Statement 16. The system of statements 11-15, wherein the power distribution comprises one or more of a power converter, a transformer, and a substation.

Statement 17. The system of statements 11-16, wherein the one or more processors are to select the power distribution for one selected electrochemical stack that is the same as the power distribution of another selected electrochemical stack.

Statement 18. The system of statements 11-17, wherein the one or more processors are to select the power distribution for one selected electrochemical stack that is different from the power distribution of another selected electrochemical stack.

Statement 19. The system of statements 11-18, wherein the one or more processors are to balance a power distribution load among a plurality of power distributions.

Statement 20. The system of statements 11-19, wherein the memory is further to store power distribution data including an indication of any power distributions that will be out of service during the particular time interval, and wherein the one or more processors are to select the power distribution for the set of electrochemical stacks comprises excluding power distributions for selection that will be out of service during the particular time interval.

Statement 21. A non-transitory computer-readable medium comprising program code that, when executed by one or more processors, cause the one or more processors to perform a method for distributing power to a hydrogen generation system, the hydrogen generation system including a plurality of electrochemical stacks, the method comprising: receiving a hydrogen generation request including an amount of hydrogen to produce during a particular time interval; receiving status data regarding the plurality of electrochemical stacks; selecting a set of electrochemical stacks of the plurality of electrochemical stacks that can fulfil the hydrogen generation request based, at least in part, on the status data; selecting a power distribution for the set of electrochemical stacks; and coupling the set of electrochemical stacks to the selected power distribution.

It can be noted that as used herein and in the appended claims, the singular forms “a,” “an,” and “the” include plural references unless the context clearly dictates otherwise. Although any systems and methods similar or equivalent to those described herein can be used in the practice or testing of embodiments, only some exemplary systems and methods are described.

Further, many of the embodiments described herein are described in terms of sequences of actions to be performed by, for example, elements of a computing device. It should be recognized by those skilled in the art that specific circuits can perform the various sequence of actions described herein (e.g., application-specific integrated circuits or “ASICs”) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in several different forms, all of which have been contemplated to be within the scope of the claimed subject matter. In addition, for each of the embodiments described herein, the corresponding form of any such embodiments may be described herein as, for example, a computer configured to perform the described action.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media, such as optical or magnetic disks and dynamic memory, respectively. Common forms of non-transitory computer-readable media include, for example, a FLASH memory, a flexible disk, a hard disk, any other magnetic medium, any other optical medium, RAM, PROM, EPROM, a FLASHEPROM, and any other memory chip or cartridge.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims.

What is claimed is:

1. A method for distributing power to a hydrogen generation system, the hydrogen generation system including a plurality of electrochemical stacks, the method comprising:
receiving a hydrogen generation request including an amount of hydrogen to produce during a particular time interval;
receiving status data regarding the plurality of electrochemical stacks;
selecting a set of electrochemical stacks of the plurality of electrochemical stacks that can fulfil the hydrogen generation request based, at least in part, on the status data;
selecting a power distribution for the set of electrochemical stacks; and
coupling the set of electrochemical stacks to the selected power distribution.

2. The method of claim 1, wherein receiving the status data includes receiving an indication of which electrochemical stacks of the plurality of electrochemical stacks are active and a rate of hydrogen production for at least one active electrochemical stack of the plurality of electrochemical stacks.

3. The method of claim 2, wherein selecting the set of electrochemical stacks comprises selecting the set of electrochemical stacks based which electrochemical stacks of the plurality of electrochemical stacks are active and the rate of hydrogen production for the at least one active electrochemical stack of the plurality of electrochemical stacks.

4. The method of claim 2, wherein the status data includes the power distribution for one or more of the plurality of electrochemical stacks, and wherein selecting the set of electrochemical stacks comprises selecting an electrochemical stack that has a same power distribution as another selected electrochemical stack.

5. The method of claim 2, wherein the status data includes the power distribution for one or more of the plurality of electrochemical stacks, and wherein selecting the set of electrochemical stacks comprises selecting an electrochemical stack that has a different power distribution as another selected electrochemical stack.

6. The method of claim 1, wherein selecting the power distribution for the set of electrochemical stacks comprises selecting one or more of a power converter, a transformer, and a substation.

7. The method of claim 1, wherein selecting the power distribution for the set of electrochemical stacks comprises selecting the power distribution for one selected electrochemical stack that is the same as the power distribution of another selected electrochemical stack.

8. The method of claim 1, wherein selecting the power distribution for the set of electrochemical stacks comprises selecting the power distribution for one selected electrochemical stack that is different from the power distribution of another selected electrochemical stack.

9. The method of claim 1, wherein selecting the power distribution for the set of electrochemical stacks comprises balancing a power distribution load among a plurality of power distributions.

10. The method of claim 1, further comprising receiving power distribution data including an indication of any power distributions that will be out of service during the particular time interval, wherein selecting the power distribution for the set of electrochemical stacks comprises excluding power distributions for selection that will be out of service during the particular time interval.

11. A system for distributing power to a hydrogen generation system, the hydrogen generation system including a plurality of electrochemical stacks, the system comprising:
a communication interface to receive a hydrogen generation request including an amount of hydrogen to produce during a particular time interval;
a memory to store status data regarding the plurality of electrochemical stacks; and
one or more processors to select a set of electrochemical stacks of the plurality of electrochemical stacks that can fulfil the hydrogen generation request based, at least in part, on the status data, wherein the processor is further to select a power distribution for the set of electrochemical stacks and initiate coupling of the set of electrochemical stacks to the selected power distribution.

12. The system of claim 11, the status data includes an indication of which electrochemical stacks of the plurality of electrochemical stacks are active and a rate of hydrogen production for at least one active electrochemical stack of the plurality of electrochemical stacks.

13. The system of claim 12, wherein the one or more processors are to select the set of electrochemical stacks based which electrochemical stacks of the plurality of electrochemical stacks are active and the rate of hydrogen production for the at least one active electrochemical stack of the plurality of electrochemical stacks.

14. The system of claim 12, wherein the status data includes the power distribution for one or more of the plurality of electrochemical stacks, and wherein the one or more processors are to select an electrochemical stack that has a same power distribution as another selected electrochemical stack.

15. The system of claim 12, wherein the status data includes the power distribution for one or more of the plurality of electrochemical stacks, and wherein the one or more processors are to select an electrochemical stack that has a different power distribution as another selected electrochemical stack.

16. The system of claim 11, wherein the power distribution comprises one or more of a power converter, a transformer, and a substation.

17. The system of claim 11, wherein the one or more processors are to select the power distribution for one selected electrochemical stack that is the same as the power distribution of another selected electrochemical stack.

18. The system of claim 11, wherein the one or more processors are to select the power distribution for one selected electrochemical stack that is different from the power distribution of another selected electrochemical stack.

19. The system of claim 11, wherein the one or more processors are to balance a power distribution load among a plurality of power distributions.

20. The system of claim 11, wherein the memory is further to store power distribution data including an indication of any power distributions that will be out of service during the particular time interval, and wherein the one or more processors are to select the power distribution for the set of electrochemical stacks by excluding power distributions for selection that will be out of service during the particular time interval.

21. A non-transitory computer-readable medium comprising program code that, when executed by one or more processors, cause the one or more processors to perform a method for distributing power to a hydrogen generation system, the hydrogen generation system including a plurality of electrochemical stacks, the method comprising:
receiving a hydrogen generation request including an amount of hydrogen to produce during a particular time interval;
receiving status data regarding the plurality of electrochemical stacks;
selecting a set of electrochemical stacks of the plurality of electrochemical stacks that can fulfil the hydrogen generation request based, at least in part, on the status data;
selecting a power distribution for the set of electrochemical stacks; and
coupling the set of electrochemical stacks to the selected power distribution.
